(19) United States
(12) Patent Application Publication
(10) Pub. No.: US 2014/0085430 A1
(43) Pub. Date: Mar. 27, 2014

(54) BINOCULAR IMAGE PICK-UP DEVICE, CONTROL METHOD, AND COMPUTER-READABLE RECORDING MEDIUM

(71) Applicants: Kohji Komori, Osaka-shi (JP); Kaiji Nabetani, Osaka-shi (JP)

(72) Inventors: Kohji Komori, Osaka-shi (JP); Kaiji Nabetani, Osaka-shi (JP)

(73) Assignee: SHARP KABUSHIKI KAISHA, Osaka-shi, Osaka (JP)

(21) Appl. No.: 14/116,187

(22) PCT Filed: May 11, 2012
(86) PCT No.: PCT/JP2012/062225

§ 371 Date: Nov. 7, 2013

(30) Foreign Application Priority Data
May 11, 2011 (JP) 2011-106314

(51) Int. Cl. H04N 13/02

(52) U.S. Cl. CPC H04N 13/0239
USPC 348/47

(57) ABSTRACT

A mobile device (1) switches, according to whether or not the mobile device (1) is in a regular orientation in which a primary image capturing section (11) and a secondary image capturing section (12) can respectively capture left-eye and right-eye images, between (a) a 2D image capturing mode in which a recognizable direction of a sign on a display screen is changed and (b) a 3D image capturing mode in which a direction of the sign, which direction is displayed while the mobile device (1) is in the regular orientation, is maintained. Furthermore, the mobile device (1) switches to the 3D image capturing mode in a case where the primary image capturing section (11) and the secondary image capturing section (12) capture left-eye and right-eye images, respectively.

### TECHNICAL FIELD

The present invention relates to (i) a twin-lens image capturing device (binocular image pick-up device) including a twin-lens camera, (ii) a method of controlling the twin-lens image capturing device (control method), (iii) a control program, and (iv) a computer-readable storage medium-(computer-readable recording medium).

### BACKGROUND ART

In recent years, high performance mobile phones, known as smartphones, have been prevalent in the market. Smartphones are equipped with a communication function, an information processing function, and other various functions.

Examples of a wide variety of functions of smartphones encompass a video image playback function, a web browsing function, an E-mail function, a scheduler function, and a camera function.

Furthermore, many of the latest smartphones employ a touch panel as user interface (hereinafter abbreviated to “UI”). This makes intuitive operations possible.

In contrast, smartphones have a decreasing number of physical buttons such as those buttons used for many of conventional mobile phones.

Hence, in some cases, vertical and horizontal orientations (hereinafter referred to simply as “orientation”) of a smartphone having few physical buttons are difficult to determine. Therefore, in a case where, for example, the smartphone is subject to a restriction such as a proper orientation for performing a certain function, a user may find it difficult to properly orient the smartphone.

For example, in a case where the user is about to capture an image with the use of a camera function but is holding the smartphone upside down, the user needs to determine a proper orientation for image capturing. In this case, the user is to determine the orientation of the smartphone by referring to, for example, how texts and icons are displayed, in relation to each other, on a camera-function screen.

In view of the circumstances, proposals have conventionally been made for technologies (see Patent Literatures 1 through 6) in which a warning sign is displayed or image capturing is disabled if a smartphone is not properly oriented.

Proposals have also been made for technologies in which UI is automatically rotated according to an orientation of a smartphone so that image capturing is possible without manually rotating the smartphone.

### CITATION LIST

### Patent Literatures

Patent Literature 1
Japanese Patent Application Publication, Tokukai, No. 2007-189533 A (Publication Date: Jul. 26, 2007)
Patent Literature 2
Japanese Patent Application Publication, Tokukai, No. 2011-019028 A (Publication Date: Jan. 27, 2011)
Patent Literature 3
Japanese Patent Application Publication, Tokukaihei, No. 06-148764 A (Publication Date: May 27, 1994)
Patent Literature 4
Japanese Patent Application Publication, Tokukai, No. 2007-124548 A (Publication Date: May 17, 2007)
Patent Literature 5
Japanese Patent Application Publication, Tokukai, No. 2008-010898 A (Publication Date: Jan. 17, 2008)
Patent Literature 6
Japanese Patent Application Publication, Tokukai, No. 2007-208854 A (Publication Date: Aug. 16, 2007)

### SUMMARY OF INVENTION

### Technical Problem

Some smartphones are capable of both 2D image capturing for planar images and 3D image capturing for stereoscopic images.

With some smartphones, 2D image capturing is possible without a close attention to top, bottom, right, and left directions of the smartphone, that is, an orientation of the smartphone.

On the other hand, some smartphones have such a problem that, if the 3D image is captured while a smartphone is held upside down, the 3D image is inverted from left to right due to a mechanism of a twin-lens camera which is configured to capture respective images that are specific to right and left lenses. This interferes with providing an excellent stereoscopic view of the 3D image.

Examples of such smartphones encompass those configured so that a stereoscopic image is created by combining a right-eye image (captured by a sub-lens) and a left-eye image (taken by a main lens) together through shifting the right-eye image so as to superimpose the right-eye image on the left-eye image.

Some smartphones thus have a mixture of (i) a 2D image capturing mode in which attention to the orientation of the smartphone is not necessarily required and (ii) a 3D image capturing mode in which attention to the orientation of the smartphone is required. This may advantageously cause a user to be confused about whether or not the user should be aware of the orientation of the smartphone. Therefore, it is desirable that a user of a smartphone be made aware, when necessary, of the orientation of the smartphone.

The present invention has been made in view of the problem, and it is an object of the present invention to achieve (i) a twin-lens image capturing device capable of allowing a user to recognize an orientation of the device by use of a sign on a display screen in a case where the user attempts to capture a stereoscopic image whose vertical and horizontal orientations are distinct from each other, (ii) a method of controlling the twin-lens image capturing device, (iii) a control program, and (iv) a computer-readable storage medium.

### Solution to Problem

In order to attain the object, a twin-lens image capturing device of the present invention includes: first and second image capturing sections for respectively generating a right-eye image and a left-eye image which are used to generate a stereoscopic image; orientation determining means for determining whether or not an orientation of the twin-lens image capturing device is a regular orientation in which the first and second image capturing sections can capture a right-eye image and a left-eye image, respectively; sign displaying means for displaying a sign on a display screen, a direction of which sign is recognizable; and mode switching means for switching between (i) an orientation following mode in which the sign displaying means changes the direction of the sign in accordance with the orientation of the twin-lens image capturing device and (ii) an orientation maintaining mode in which the sign displaying means causes a direction of the sign, which direction is displayed while the twin-lens image capturing device is in the regular orientation, to be maintained, the mode switching means switching to the orientation maintaining mode in a case where the first and second image capturing sections capture a right-eye image and a left-eye image, respectively.

In order to attain the object, a method of the present invention is a method of controlling a twin-lens image capturing device, which includes first and second image capturing sections for respectively generating a right-eye image and a left-eye image which are used to generate a stereoscopic image, said method including the steps of: (a) determining whether or not an orientation of the twin-lens image capturing device is a regular orientation in which the first and second image capturing sections can capture a right-eye image and a left-eye image, respectively; (b) changing a direction of a sign, which direction is recognizable, in accordance with the orientation determined in the step (a); (c) causing a direction of the sign, which direction is displayed while the twin-lens image capturing device is in the regular orientation, to be maintained; and (d) switching from the step (b) to the step (c) in a case where the first and second image capturing sections capture a right-eye image and a left-eye image, respectively.

According to the configuration, two images, a right-eye image and a left-eye image, are captured. This allows a stereoscopic image to be generated. Note that the two images can be still images or video images.

A method of generating the stereoscopic image is not limited to any particular one, provided that the right-eye image and the left-eye image captured by a twin-lens camera are used to generate the stereoscopic image. For example, a conventional technique such as the side-by-side method can be employed.

Note that one of the right-eye image and the left-eye image can be a primary image in generating the stereoscopic image, and the other one can be a secondary image in generating the stereoscopic image. In such a case, the stereoscopic image can be generated by superimposing the secondary image on the primary image.

It can be said that the orientation of the twin-lens image capturing device is determined based on how the first and second image capturing sections, which respectively capture the right-eye image and the left-eye image, are horizontally arranged in relation to each other.

Note that the regular orientation, in which the left-eye image and the right-eye image can be captured, is an orientation in which (i) the second image capturing section for capturing the left-eye image is located to the left of an object whose image is to be captured and (ii) the first image capturing section for capturing the right-eye image is located to the right of the object.

That is, in a case where the twin-lens image capturing device is upside down, (i) the second image capturing section for capturing the left-eye image is located to the right of the object and (ii) the first image capturing section for capturing the right-eye image is located to the left of the object.

Therefore, the regular orientation is, in other words, an orientation in which (i) the first and second image capturing sections are arranged in line that is parallel to the ground and (ii) the twin-lens image capturing device is not upside down.

Note that the sign whose direction is recognizable means a sign or a plurality of signs whose top, down, right, and left are identifiable. Examples of the sign encompass icons, button, and messages to be displayed on the display screen. Note also that, in the above configuration, the display screen can be configured by a touch panel.

Furthermore, according to the configuration, the twin-lens image capturing device has an orientation maintaining mode in which a direction of the sign on the display screen, which direction is displayed while the twin-lens image capturing device is in the regular orientation, is maintained even while the twin-lens image capturing device is not in the regular orientation.

According to the configuration, the twin-lens image capturing device also has an orientation following mode in which the direction of the sign on the display screen is changed according to the orientation of the twin-lens image capturing device. This is because, for example, there are cases where it is more convenient for a user if the direction of the sing does not change from the user's perspective even when the twin-lens image capturing device is upside down, such as a case where a planar image is to be captured.

According to the configuration, it is thus possible to switch between the orientation following mode and the orientation maintaining mode.

Furthermore, according to the configuration, a switch to the orientation maintaining mode is made in a case where images for generation of a stereoscopic image are to be captured.

Hence, it is possible to allow a user to recognize the orientation of the twin-lens image capturing device by use of the sign on the display screen in a case where the user attempts to capture a stereoscopic image whose vertical and horizontal orientations are distinct from each other.

Note that the twin-lens image capturing device can be realized by a computer. In such a case, the scope of present invention encompasses (i) a program for controlling the twin-lens image capturing device which program achieves the twin-lens image capturing device with the use of a computer by causing the computer to serve as each of the means included in the twin-lens image capturing device and (ii) a computer-readable storage medium in which the program is stored.

### Advantageous Effects of Invention

A twin-lens image capturing device of the present invention includes: orientation determining means for determining whether or not an orientation of the twin-lens image capturing device is a regular orientation in which first and second image capturing sections can capture a right-eye image and a left-eye image, respectively; sign displaying means for displaying a sign on a display screen, a direction of which sign is recognizable; and mode switching means for switching between (i) an orientation following mode in which the sign displaying means changes the direction of the sign in accordance with the orientation of the twin-lens image capturing device and (ii) an orientation maintaining mode in which the sign displaying means causes a direction of the sign, which direction is displayed while the twin-lens image capturing device is in the regular orientation, to be maintained, the mode switching means switching to the orientation maintaining mode in a case where the first and second image capturing sections capture a right-eye image and a left-eye image, respectively.

A method of the present invention includes the steps of: (a) determining whether or not an orientation of a twin-lens image capturing device is a regular orientation in which first and second image capturing sections can capture a right-eye image and a left-eye image, respectively; (b) changing a direction of a sign, which direction is recognizable, in accordance with the orientation determined in the step (a); (c) causing a direction of the sign, which direction is displayed while the twin-lens image capturing device is in the regular orientation, to be maintained; and (d) switching from the step (b) to the step (c) in a case where the first and second image capturing sections capture a right-eye image and a left-eye image, respectively.

Therefore, such advantageous effects are brought about that it is possible to allow a user to recognize the orientation of the twin-lens image capturing device by use of a sign on the display screen in a case where the user attempts to capture a stereoscopic image whose vertical and horizontal orientations are distinct from each other.

### BRIEF DESCRIPTION OF DRAWINGS

FIG. 1 is a block functional diagram schematically illustrating an example of functions of a mobile device in accordance with an embodiment of the present invention.

FIG. 2 is a view illustrating an external appearance of the mobile device. (a) of FIG. 2 illustrates a surface (front surface) of the mobile device on which a touch panel display section is provided. (b) of FIG. 2 illustrates a surface (back surface) of the mobile device on which a twin-lens camera section is provided. (c) of FIG. 2 illustrates respective locations of the touch panel display section and the twin-lens camera section in relation to each other.

FIG. 3 is a table illustrating a specific example of display control settings stored in the mobile device.

FIG. 4 is a flow chart illustrating an example of a flow of a sign displaying process of the mobile device.

FIG. 5 illustrates an example of a display on a display screen of the mobile device in each orientation in a 2D image capturing mode. (a), (b), (c), and (d) of FIG. 5 illustrate examples in which the mobile device is in “home” orientation, “rightward 90° rotation” orientation, “rightward 180° rotation” orientation, and “rightward 270° (leftward 90° rotation)” orientation, respectively.

FIG. 6 illustrates an example of a display on a display screen of the mobile device in each orientation in a 3D image capturing mode. (a), (b), (c), and (d) of FIG. 6 illustrate examples in which the mobile device is in “home” orientation, “rightward 90° rotation” orientation, “rightward 180° rotation” orientation, and “rightward 270° (leftward 90° rotation)” orientation, respectively.

FIG. 7 is a view illustrating an example of how a text-based alert is issued in the 3D image capturing mode.

FIG. 8 illustrates an example of a display on a display screen of the mobile device in each orientation in a 3D image capturing mode while a video image is being captured. (a), (b), (c), and (d) of FIG. 8 illustrate examples in which the mobile device is in “home” orientation, “rightward 90° rotation” orientation, “rightward 180° rotation” orientation, and “rightward 270° (leftward 90° rotation)” orientation, respectively.

FIG. 9 illustrates a modification of a display on a display screen of the mobile device in each orientation in a 2D image capturing mode. (a), (b), (c), and (d) of FIG. 9 illustrate examples in which the mobile device is in “home” orientation, “rightward 90° rotation” orientation, “rightward 180° rotation” orientation, and “rightward 270° (leftward 90° rotation)” orientation, respectively.

FIG. 10 illustrates another modification of a display on a display screen of the mobile device in each orientation in a 3D image capturing mode. (a), (b), (c), and (d) of FIG. 10 illustrate examples in which the mobile device is in “home” orientation, “rightward 90° rotation” orientation, “rightward 180° rotation” orientation, and “rightward 270° (leftward 90° rotation)” orientation, respectively.

FIG. 11 illustrates a further modification of a display on a display screen of the mobile device in each orientation in a 3D image capturing mode. (a), (b), (c), and (d) of FIG. 11 illustrate examples in which the mobile device is in “home” orientation, “rightward 90° rotation” orientation, “rightward 180° rotation” orientation, and “rightward 270° (leftward 90° rotation)” orientation, respectively.

FIG. 12 illustrates an even further modification of a display on a display screen of the mobile device in each orientation in a 3D image capturing mode. (a), (b), (c), and (d) of FIG. 12 illustrate examples in which the mobile device is in “home” orientation, “rightward 90° rotation” orientation, “rightward 180° rotation” orientation, and “rightward 270° (leftward 90° rotation)” orientation, respectively.

FIG. 13 is a view illustrating a modification of a 2D/3D mode switching button.

### DESCRIPTION OF EMBODIMENTS

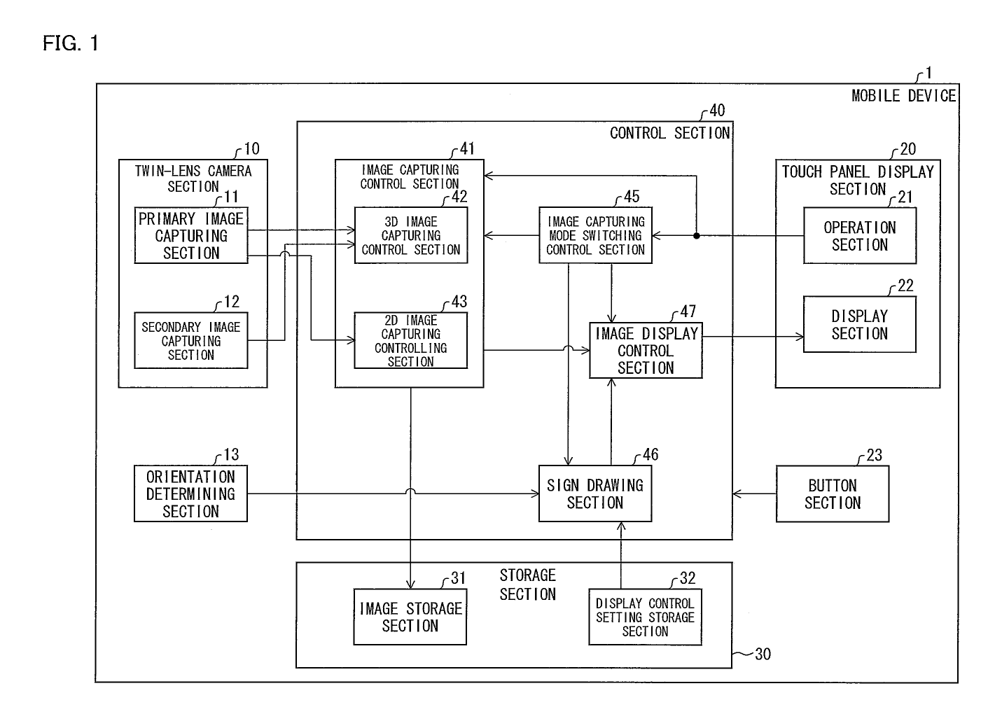

The following description will discuss an embodiment of the present invention with reference to FIGS. 1 through 13.

(Outward Appearance of Mobile Device)

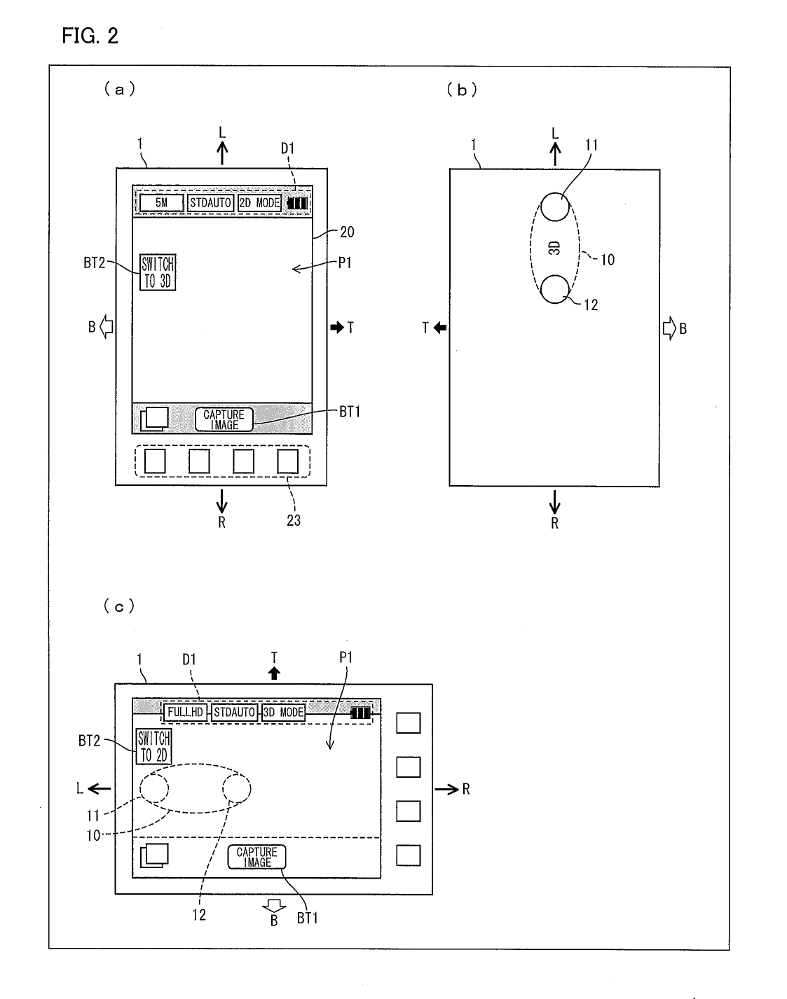

An outward appearance of a mobile device (twin-lens image capturing device) 1 in accordance with the present embodiment will be described below with reference to FIG. 2. FIG. 2 is a view illustrating the outward appearance of the mobile device 1.

The mobile device 1 is, for example, (a) a high performance mobile device, known as a smartphone or (b) a tablet information device. The mobile device 1 includes (i) a twin-lens camera section 10 (made up of two image capturing sections) for 2D image capturing and 3D image capturing and (ii) a touch panel display section 20 (sign displaying means) for a touch operation.

A display screen of the mobile device 1 will be described first with reference to (a) of FIG. 2. For convenience, a surface illustrated in (a) of FIG. 2 will be regarded as a front surface of the mobile device 1. (a) of FIG. 2 illustrates an outward appearance of the front surface of the mobile device 1.

As illustrated in (a) of FIG. 2, the touch panel display section 20 and a button section 23 are provided on the front surface of the mobile device 1.

The touch panel display section 20 accepts a touch input as well as displays an image.

The button section 23 is made up of at least one physical button for various operations on the mobile device 1.

A back surface of the mobile device 1 will be described next with reference to (b) of FIG. 2. That is, (b) of FIG. 2 illustrates an outward appearance of the back surface (flipped side) of the mobile device 1.

As illustrated in (b) of FIG. 2, the mobile device 1 further includes a twin-lens camera section 10 for 2D image capturing or 3D image capturing. The twin-lens camera section 10 includes a primary image capturing section (image capturing section) 11 and a secondary image capturing section (image capturing section) 12.

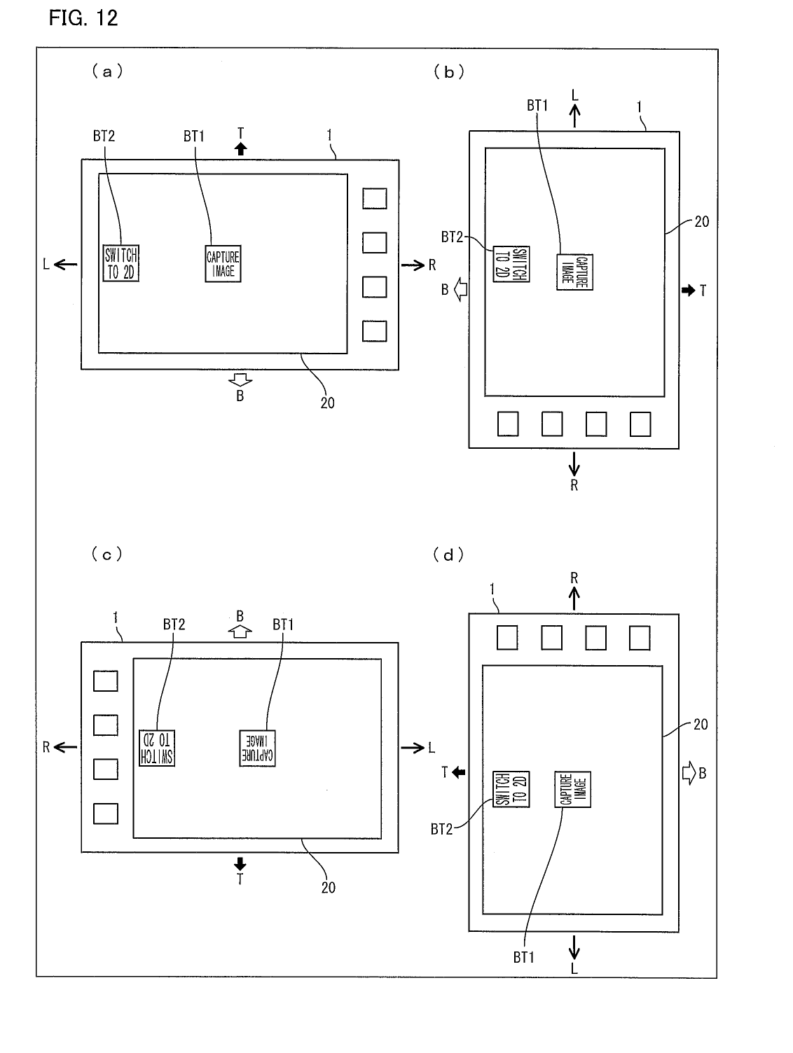

(c) of FIG. 12 illustrates a basic orientation in which the mobile device 1 captures an image object while in a 2D image capturing mode (orientation following mode) for 2D image capturing or in a 3D image capturing mode (orientation maintaining mode) for 3D image capturing. (c) of FIG. 2 also illustrates, by dotted lines, a location of the twin-lens camera section 10 which is provided on the back surface. Furthermore, top, bottom, right, and left directions from the mobile device 1 are indicated by arrows T, B, R, and L, respectively.

Specifically, in the basic orientation in which an image is captured with the use of the twin-lens camera section 10, (i) the direction of the arrow B is to be in line with a direction of gravity, so that the direction of the arrow B is a downward direction when the user looks at the mobile device 1, (ii) the direction of the arrow T is an upward direction, (iii) the primary image capturing section 11 is located toward a left end part of the twin-lens camera section 10 (as indicated by the arrow L) of the secondary image capturing section 12 and (iv) the secondary image capturing section 12 is located toward a right end part of the twin-lens camera section 10 (as indicated by the arrow R) of the primary image capturing section 11.

Hereinafter, such a basic orientation for image capturing will be referred to as “home orientation” (regular orientation). Note that home orientations for the respective 2D and 3D image capturing modes can be different. For example, the home orientation for the 2D image capturing mode can be set as illustrated in (a) of FIG. 2.

Arrows indicative of the home orientation are likewise illustrated in (a) and (b) of FIG. 2.

Note that, during 2D image capturing, the primary image capturing section 11 captures a planar image. Note also that, during 3D image capturing, (i) the primary image capturing section 11 captures a left-eye image and (ii) the secondary image capturing section 12 captures a right-eye image.

(Configuration of Mobile Device)

A function of the mobile device 1 will be described below with reference to FIG. 1. FIG. 1 is a block diagram illustrating the function of the mobile device 1.

As illustrated in FIG. 1, the mobile device 1 includes the twin-lens camera section 10, an orientation determining section (orientation determining means) 13, the touch panel display section 20, the button section 23, a storage section 30, and a control section 40.

The twin-lens camera section 10 captures an image object so as to obtain an image. As has been described, the twin-lens camera section 10 includes the primary image capturing section 11 and the secondary image capturing section 12.

Note that the primary image capturing section 11 and the secondary image capturing section 12 can each be configured by an optical system and an image capturing device (CCD (Charge Coupled Devices), CMOS (Complementary Metal-Oxide-Semiconductor), and the like).

As described earlier, the twin-lens camera section 10 is designed for the following two image capturing modes (i) and (ii): (i) the 2D image capturing mode in which the primary image capturing section 11 is used and (ii) the 3D image capturing mode in which the primary image capturing section 11 and the secondary image capturing section 12 are both used.

Note that the twin-lens camera section 10 is capable of not only capturing a still image but also capturing a video image. The following description will discuss capturing of a still image unless specifically stated otherwise.

During 3D image capturing in the 3D image capturing mode, the primary image capturing section 11 captures a left-eye image while the secondary image capturing section 12 captures a right-eye image. Then, (i) the primary image capturing section 11 transmits, to the control section 40, the left-eye image as left-eye data and (ii) the secondary image capturing section 12 transmits, to the control section 40, the right-eye image as right-eye data.

During 2D image capturing in the 2D image capturing mode, on the other hand, only the primary image capturing section 11 (i) captures an image object so as to obtain a planar image and then (ii) transmits, as planar image data, the planar image to the control section 40.

Hereinafter, data transmitted from the twin-lens camera section 10 will be referred to as “image data” in cases where (i) there is no need to signify which of left-eye image data and right-eye image data obtained during 3D image capturing is being discussed and (ii) there is no need to signify which of 2D image capturing and 3D image capturing is being discussed.

The orientation determining section 13 determines an orientation of the mobile device 1. The orientation determining section 13 can be configured by, for example, a three-axial acceleration sensor for detecting a direction of gravity and the like.

Note that (i) the term “orientation” refers to, for example, a rotational position where the mobile device 1 is located after rotating around an axis which is perpendicular to the display screen of the touch panel display section 20 and (ii) the orientation of the mobile device 1 can be indicated by a rotation angle at which the downward direction of the home orientation (i.e. the direction of the arrow B illustrated in (a) through (c) of FIG. 2) is rotated relative to the direction of gravity.

The orientation determining section 13 generates orientation data indicative of an orientation thus determined, and then transmits the orientation data to the control section 40.

The touch panel display section 20 includes (i) an operation section 21 for accepting a touch operation and (ii) a display section (sign displaying means) 22 for displaying an image.

The operation section 21 (i) determines a touch location on the display screen of the 22 which touch location has been touched by a touch operation, (ii) generates operation data, based on the touch location, and then (iii) transmits the operation data to the control section 40. Examples of a touch-locating method by which the operation section 21 determines the touch location encompass matrix-switch method, resistive film method, surface elastic wave method, infrared ray method, electromagnetic induction method, capacitive method, and a method of detecting a touch subject image (optical sensor method). Note, however, that the touch-locating method is not limited to these, but various methods can be applied to the touch-locating method.

The display section 22 has the display screen that displays image data. The display section 22 receives image data from the control section 40, and then displays, based on the image data thus received, an image on the display screen. Examples of the display section 22 encompass an LCD (Liquid Crystal Display), a PDP (Plasma Display Panel), and an EL (Electroluminescence) display.

The button section 23 is, as described earlier, made up of at least one button which is provided on the front surface of the mobile device 1. The button section 23 generates operation data based on a touch operation of a user, and then transmits the operation data to the control section 50. The storage section 30 stores various data and programs.

The control section 40 totally controls various functions of the mobile device 1. Details of configurations of the storage section 30 and the control section 40 will be described below.

(Configuration of Storage Section in Detail)

Specifically, the storage section 30 includes an image storage section 31 and a display control setting storage section 32.

The image storage section 31 is controlled by an image capturing control section 41 to store image data of an image captured by the twin-lens camera section 10. Note that image data is identified by its filename, for example. Various file formats can be employed according to whether or not the image data is of (i) a planar image captured in the 2D image capturing mode, (ii) a stereoscopic image captured in the 3D image capturing mode, (iii) a video image, (iv) a still image, or the like. Note that a filename can contain a filename extension indicative of a file format of image data.

Although not illustrated, image data to be stored in the image storage section 31 can be (i) transmitted to the touch panel display section 20 via the control section 40 and then (ii) played back on the display section 22.

The display control setting storage section 32 stores display control setting information indicative of a display control setting at which the touch panel display section 20 is set to display image data. Display control setting information, specifically, indicates an association between the orientation of the mobile device 1 and a direction of a displayed sign. The details of the sign will be described later in detail.

The display control setting can be classified roughly into two types of settings, i.e., a still image setting and a video image setting. The still image setting and the video image setting can each be further classified into (i) a 2D image capturing mode display control setting for use in the 2D image capturing mode and (ii) 3D image capturing mode display control setting for use in the 3D image capturing.

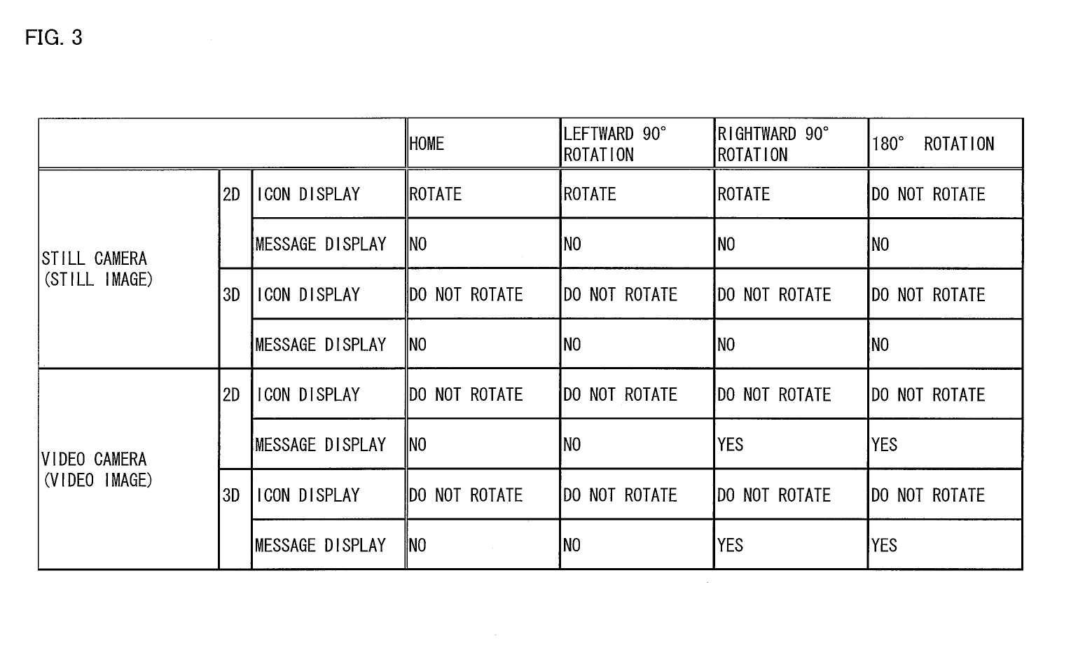

A specific example of the display control setting will be described below with reference to FIG. 3. FIG. 3 is a table illustrating a specific example of the display control setting.

As illustrated in FIG. 3, the display control setting is grouped into the still image setting “Still Image” and the video image setting “Video Image.” The still image setting and the video image setting are each grouped into (i) the 2D image capturing mode display control setting (indicated by “2D” in FIG. 3) and (ii) the 3D image capturing mode display control setting (indicated by “3D” in FIG. 3).

“2D” and “3D” are each grouped into (i) a setting of an icon to be displayed on the screen (indicated by “Icon Display” in FIG. 3) and (ii) a setting of a message to be displayed on the screen (indicated by “Message Display” in FIG. 3).

As illustrated in FIG. 3, with regard to each of “Icon Display” and “Message Display,” operations for respective orientations of the mobile device 1 are set.

Specifically, the orientations of the mobile device 1 include “Home”, “Leftward 90° Rotation”, “Rightward 90° Rotation”, and “180° Rotation.”

According to “Icon Display,” it is possible to set directions of a sign for the respective orientations.

According to “Message Display”, it is possible to set whether or not a message is to be displayed for each of the orientations of the mobile device 1.

For example, according to “Still Image-2D-Icon Display”, “Rotate” is set for each orientation of “Home”, “Leftward 90° Rotation”, and “Rightward 90° Rotation.” “Rotate” refers to rotating an icon in accordance with the orientation of the mobile device 1 so that the downward direction of the icon is in line with the direction of gravity. When a user looks at the mobile device 1, the direction of the icon appears to remain the same, regardless of the orientation of the mobile device 1.

According to “Still Image-3D-Icon Display”, for example, “Do Not Rotate” is set for all of the four orientations of the mobile device 1. “Do Not Rotate” refers to not rotating an icon in accordance with the orientation of the mobile device 1.

(Configuration of Control Section in Detail)

As illustrated in FIG. 1, the control section 40 includes the image capturing control section 41, an image capturing mode switching control section (mode switching means) 45, a sign drawing section (sign displaying means, alerting means) 46, and an image display control section 47.

The image capturing control section 41 controls the twin-lens camera section 10 to obtain a captured image. In addition, the image capturing control section 41 transfers, to the image display control section 47, image data obtained from the primary image capturing section 11.

Furthermore, the image capturing control section 41 (i) generates stereoscopic image data, based on image data obtained from the primary image capturing section 11 and the secondary image capturing section 12 and then (ii) transfers the stereoscopic image data to the image display control section 47.

More specifically, the image capturing control section 41 includes (i) a 3D image capturing control section 42 for controlling the 3D image capturing mode and (ii) a 2D image capturing controlling section (planar image capturing means) 43 for controlling the 2D image capturing mode.

In the 3D image capturing mode, the 3D image capturing control section 42 obtains captured image data, and then generates a stereoscopic image based on the captured image data.

The 3D image capturing control section 42 generates a stereoscopic image as follows: First, the 3D image capturing control section 42 controls the primary image capturing section 11 and the secondary image capturing section 12 to (i) capture respective images of an object so as to obtain left-eye image data and right-eye image data, respectively, and then (ii) transmit the left-eye image data and the right-eye image data, respectively, to the 3D image capturing control section 42.

Subsequently, the 3D image capturing control section 42 generates stereoscopic image data by integrating the right-eye image data with the left-eye image data. That is, in generation of stereoscopic image data, the 3D image capturing control section 42 manages, for example, (i) left-eye image data as a primary one and (ii) right-eye image data as a secondary one.

Note that a conventional technology, such as a side-by-side method, can be employed as a method of integration of secondary image data with primary image data. The 3D image capturing control section 42 stores the stereoscopic image data in the image storage section 31.

In the 2D image capturing mode, the 2D image capturing controlling section 43 controls the primary image capturing section 11 to (i) capture an image so as to obtain planar image data and then (ii) transmit the planar image data to the 2D image capturing controlling section 43. The 2D image capturing controlling section 43 stores the planar image data in the image storage section 31.

The image capturing mode switching control section 45 switches, in response to a touch operation on the touch panel display section 20, between the 2D image capturing mode and the 3D image capturing mode. Specifically, the image capturing mode switching control section 45 transmits an image capturing mode switching instruction to the image capturing control section 41 in response to operation data, indicative of a mode switching operation, received from the touch panel display section 20.

The sign drawing section 46 draws a sign to be displayed on the display section 22 of the touch panel display section 20.

The sign is used to display information, and is configured so that a direction of the sign is recognizable to a user. Specific examples of the sign encompass indicators, text, figures, symbols, and any combination (as icons) of these, all of which are recognizable in terms of their respective directions. Other specific examples of the sign encompass text messages such as those indicative of available help and of an alert. Note that image data for displaying icons, text information for composing text messages, and the like, can be stored beforehand in the storage section 30.

Specifically, the sign drawing section 46 determines a direction of and a location of a sign on the display screen. The direction of the sign on the display screen means, for example, a direction of a character to be displayed. The location of the sign on the display screen means, for example, coordinates of the sign on the display section 22 as a two-dimensional graph in which an upper left corner is set to be a point of origin.

Note that the location of the sign can be predetermined or can be changed by a user setting.

The sign drawing section 46 produces, in accordance with a display control setting stored in the display control setting storage section 32, (i) sign image data containing data on an icon which (a) is to be displayed at a predetermined location and (b) is rotated according to the orientation of the mobile device 1, the orientation having been determined by the orientation determining section 13 and (ii) sign image data containing data on a text message which (a) is to be displayed at a predetermined location and (b) is rotated according to the orientation of the mobile device 1, the orientation having been determined by the orientation determining section 13.

Then, the sign drawing section 46 transmits, to the image display control section 47, the sign image data thus produced.

The image display control section 47 controls how an image is displayed on the screen of the display section 22. Specifically, the image display control section 47 (i) combines (a) image data received from the image capturing control section 41 and (b) sign image data received from the sign drawing section 46 and then (ii) transmits combined image data to the display section 22.

(Example of Display on Display Screen)

The following description will discuss, with reference to FIG. 2, a more specific example of a display on the display screen of the touch panel display section 20.

The following signs (i) through (iii) are displayed on the display screen of the touch panel display section 20 illustrated in (a) and (c) of FIG. 2 displays, in accordance with the sign image data drawn by the sign drawing section 46: (i) an indicator section (sign) D1, (ii) an image capturing button (sign) BT1, and (iii) a 2D/3D mode switching button (sign) BT2 (see (a) and (c) of FIG. 2). Note that, hereinafter, any combination of the indicator section D1, the image capturing button BT1, and the 2D/3D mode switching button BT2 may be collectively referred to as “buttons etc.”

The sign drawing section 46 draws various pieces of information concerning the camera function of the mobile device 1, which various pieces of information are to be shown in the indicator section D1.

The indicator section D1 shows, for example, a remaining battery level and three types of setting information. The three types of setting information are resolution, a scene/focus setting, and an image capturing mode, in this order from the left-hand side of (a) or (c) of FIG. 2.

(a) of FIG. 2 illustrates an example of how the indicator section D1 shows the information in the 2D image capturing mode. In this example, the indicator section D1 shows, as the three types of setting information, “5M”, “STD AUTO”, and “2D mode”, in this order from the left-hand side.

(c) of FIG. 2 illustrates an example of how the indicator section D1 shows the information in the 3D image capturing mode. In this example, the indicator section D1 shows, as the three types of setting information, “FULL HD”, “STD AUTO”, and “3D mode”, in this order from the left-hand side.

The image capturing button BT1 and the 2D/3D mode switching button BT2 are each a soft button for operating the camera function.

The image capturing button BT1 is to be used to instruct, in each of the 2D and 3D image capturing modes, the image capturing control section 41 to capture a still image. The image capturing button BT1 shows, therein, a caption “Capture Image.”

The 2D/3D mode switching button BT2 is to be used to instruct the image capturing mode switching control section 45 to switch between the 2D and 3D image capturing modes.

In the 3D image capturing mode, the 2D/3D mode switching button BT2 shows, therein, a caption “Switch to 2D” (see (c) of FIG. 2). In the 2D image capturing mode, the 2D/3D mode switching button BT2 shows, therein, a caption “Switch to 3D” (see (a) of FIG. 2).

Note that, as illustrated in (a) and (c) of FIG. 2, a user can determine top, down, left, and right directions of the mobile device 1 by a direction of the caption (text) shown in the 2D/3D mode switching button BT2.

Although the orientation (top, down, right, or left direction) of the mobile device 1 is determined by the direction of the caption in the example above, a method of determining the orientation of the mobile device 1 is not limited to such. For example, the orientation of the mobile device 1 can be determined by a symbol such as an arrow, which is contained in the caption. The same principle also applies to the indicator section D1.

The display screen of the touch panel display section 20 contains a camera screen P1 for displaying a captured image obtained by the twin-lens camera section 10.

Note that it is also possible that the display screen displays a menu button allowing a user to select from various operations and options.

(Flow of Process)

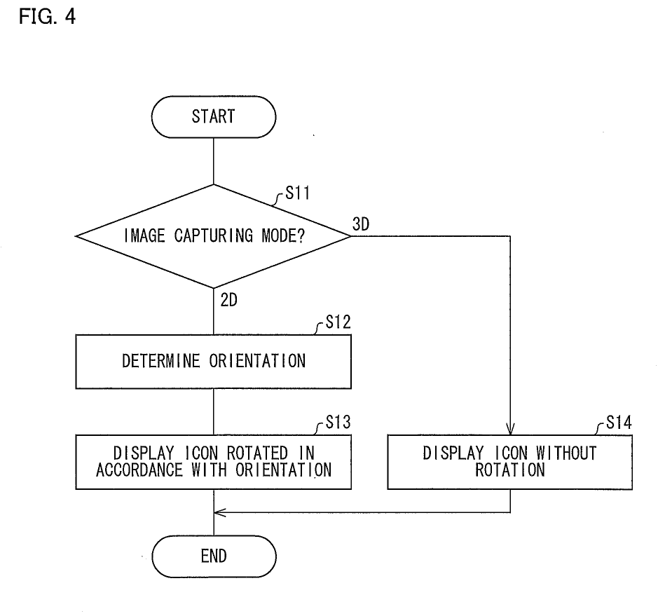

An example of a sign display process in which a sign is displayed on the mobile device 1 will be described below with reference to FIG. 4. FIG. 4 is a flow chart illustrating an example of the sign display process.

First, the sign drawing section 46 determines an image capturing mode (S11). In a case where the 2D image capturing mode is selected by the image capturing mode switching control section 45 (2D in S11), the orientation determining section 13 determines an orientation of the mobile device 1 (S12).

Specifically, in a case where the image capturing mode switching control section 45 notifies the sign drawing section 46 that the 2D image capturing mode has been selected (2D in S11), the sign drawing section 46 instructs the orientation determining section 13 to determine an orientation of the mobile device 1. In response to the instruction of the sign drawing section 46, the orientation determining section 13 determines the orientation of the mobile device 1 (S12), and then notifies the sign drawing section 46 of the orientation of the mobile device 1 thus determined.

Then, in accordance with a display control setting for the Still Image-2D-Icon Display illustrated in FIG. 3, the sign drawing section 46 draws an icon that is specific to the orientation of the mobile device 1 (S13). Specifically, the sign drawing section 46 draws an icon so that a downward direction from the icon is always in line with the direction of gravity in cases where the orientation of the mobile device 1 is “Home”, “Leftward 90° Rotation”, and “Rightward 90°Rotation.”

In other words, the sign drawing section 46 causes the display section 22 to display an icon based on (i) the display control setting information which the sign drawing section 46 has read out from the display control setting storage section 32 and (ii) the orientation of the mobile device 1 which orientation has been notified of by the orientation determining section 13.

Note that, in a case where the orientation of the mobile device 1 is “180° Rotation”, an immediately preceding direction of an icon is maintained since “Do Not Rotate” is set for a case where the orientation of the mobile device is “180°.

On the other hand, in a case where the 3D image capturing mode is selected by the image capturing mode switching control section 45 (3D in S11), the sign drawing section 46 maintains a home orientation of the icon, regardless of the orientation of the mobile device 1 (S14). This is because “Do Not Rotate” is set for each orientation of the mobile device 1.

Specifically, in a case where the image capturing mode switching control section 45 notifies the sign drawing section 46 that the 3D image capturing mode has been selected (3D in S11), the sign drawing section 46 reads out the display control setting information from the display control setting storage section 32. Since “Do Not Rotate” is set for each orientation of the mobile device 1 according to Still Image-3D-Icon Display in the display control setting information illustrated in FIG. 3, the sign drawing section 46 displays the icon without changing the home orientation of the icon, regardless of the orientation of the mobile device 1 (S14).

Then, the sign display process is ended.

### SPECIFIC EXAMPLES

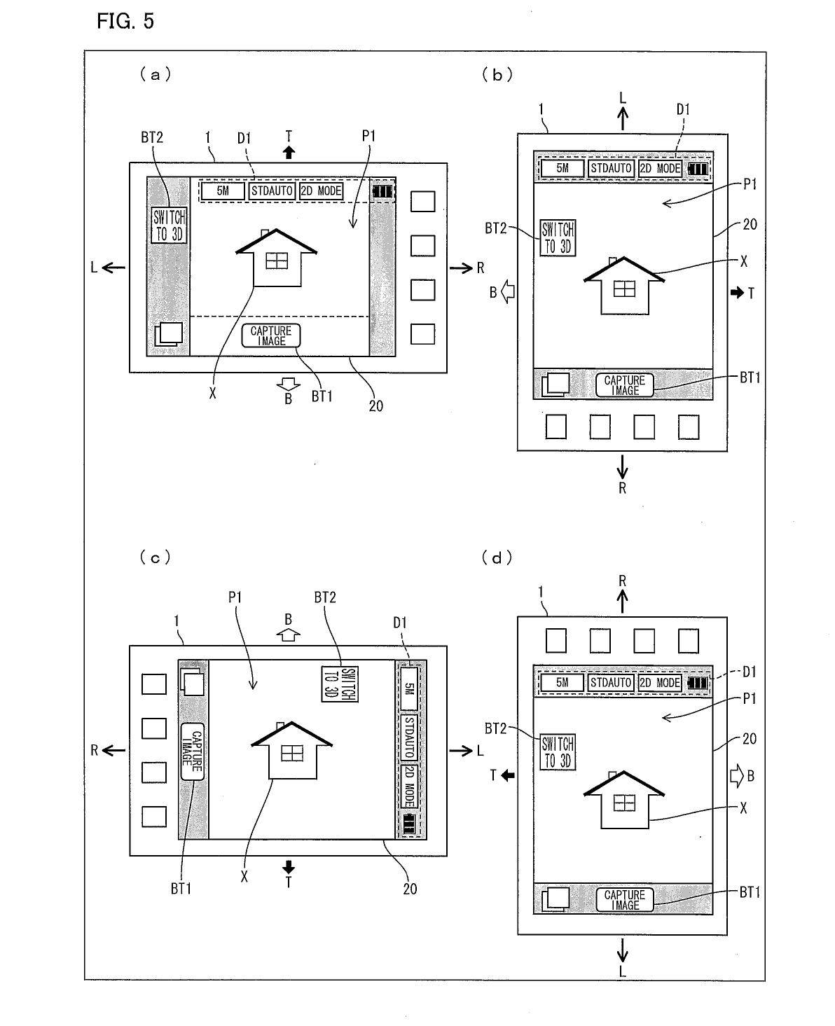

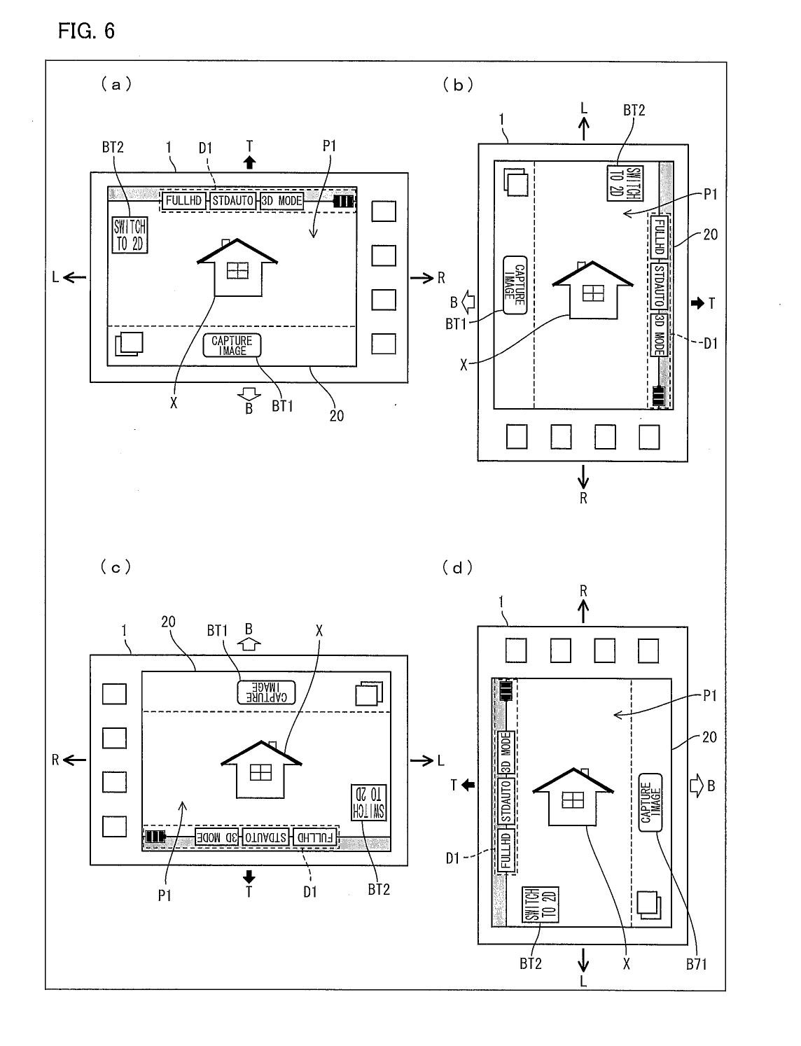

Examples of a display on a display screen in 2D and 3D image capturing modes will be described below with reference to FIGS. 5 and 6.

[2D Image Capturing Mode]

Examples of the display on the display screen in the 2D image capturing mode will be described below with reference to FIG. 5. (a) of FIG. 5 illustrates an example of the display on the display screen in a case where the orientation of the mobile device 1 is the home orientation.

A camera screen P1 shows an image captured by the primary image capturing section 11. An image of an object X is displayed as the image.

The display screen of the touch panel display section 20 displays an image capturing button BT1 and a 2D/3D mode switching button BT2. In so doing, top, down, right, and left of each caption, which is shown in the image capturing button BT1 and the 2D/3D mode switching button BT2, match top, down, right, and left (indicated by arrows T, B, R, and L illustrated in FIG. 5) of the mobile device 1. The same is true of an indicator section D1.

Note that (i) the image capturing button BT1 is located at a lower middle part of the display screen and (ii) the 2D/3D mode switching button BT2 is located at a part of the display screen which part is slightly higher than and to the left of a center part.

The following description will discuss examples of a display on the display screen in a case where the orientation of the mobile device 1 is rotated from the home orientation. (b) of FIG. 5 illustrates an example of a display on the display screen in a case where the mobile device 1 is rotated to the right by 90° from the home orientation.

Note that the directions of the buttons etc. on the display screen are rotated so that the directions of the respective captions remain the same when the user looks at the mobile device 1. Specifically, the directions of the respective captions, which are shown in the image capturing button BT1 and the 2D/3D mode switching button BT2, are rotated. The same principle applies to how the indicator section D1 shows information.

(c) of FIG. 5 illustrates an example of a display on the display screen in a case where the mobile device 1 is further rotated to the right by 90° from the orientation illustrated in (b) of FIG. 5. To put it another way, the orientation of the mobile device 1 as illustrated in (c) of FIG. 5 is rotated to the right by 180° from the home orientation. The downward direction (indicated by the arrow B) of the mobile device 1 orients upwards in this view.

In this example, an immediately preceding state of the display on the display screen (illustrated in (b) of FIG. 5) is maintained, in accordance with “Do Not Rotate”, which is the display control setting for the Still Image-2D-Icon Display illustrated in FIG. 3.

(d) of FIG. 5 illustrates an example of a display on the display screen in a case where the mobile device 1 is further rotated to the right by 90° from the orientation illustrated in (c) of FIG. 5. That is, the orientation of the mobile device 1 as illustrated in (d) of FIG. 5 is rotated to the right by 270° from the home orientation. To put it another way, the orientation of the mobile device 1 as illustrated in (d) of FIG. 5 is rotated to the left by 90° from the home orientation.

In this example, the directions of the buttons etc. on the display screen are rotated in accordance with “Rotate”, which is the display control setting for the Still Image-2D-Icon Display illustrated in FIG. 3.

Specifically, the directions of the respective captions, which are shown in the image capturing button BT1 and the 2D/3D mode switching button BT2, are rotated so that the directions of the captions remain the same when the user looks at the mobile device 1. The same principle applies to how the indicator section D1 shows information.

The mobile device 1 returns to the home orientation illustrated in (a) of FIG. 5 in a case where the mobile device 1 is rotated to the right by 90° from the orientation illustrated in (d) of FIG. 5.

[3D Image Capturing Mode]

Examples of the display on the display screen in the 3D image capturing mode will be described below with reference to FIG. 6. (a) of FIG. 6 illustrates an example of a display on the display screen in a case where the orientation of the mobile device 1 is the home orientation.

The mobile device 1 as illustrated in FIG. 6 follows the display control setting illustrated in FIG. 3. Specifically, the mobile device 1 as illustrated in FIG. 6 follows a display control setting for the Still Image-3D-Icon Display row illustrated in FIG. 3.

A camera screen P1 shows an image captured by the primary image capturing section 11. An image of an object X is displayed as the image.

The display screen of the touch panel display section 20 displays an image capturing button BT1 and a 2D/3D mode switching button BT2. In so doing, top, down, right, and left of each caption, which is shown in the image capturing button BT1 and the 2D/3D mode switching button BT2, match top, down, right and left (indicated by arrows T, B, R, and L illustrated in FIG. 5) of the mobile device 1. The same is true of an indicator section D1.

Note that respective arrangements of the image capturing button BT1 and the 2D/3D mode switching button BT2 are identical to those illustrated in (a) of FIG. 5. That is, (i) the image capturing button BT1 is located at a lower middle part of the display screen and (ii) the 2D/3D mode switching button BT2 is located at a part of the display screen which part is slightly higher than and to the left of a center part.

The following description will discuss examples of a display on the display screen in a case where the orientation of the mobile device 1 is rotated from the home orientation. (b) of FIG. 6 illustrates an example of a display on the display screen in a case where the mobile device 1 is rotated to the right by 90° from the home orientation.

In this example, it is still maintained how the buttons etc. are displayed on the display screen in the home orientation (as illustrated in (a) of FIG. 6). This causes the buttons etc. to rotate to the right by 90° along with the rotation of the mobile device 1 when the user looks at the mobile device 1. The same principle applies to the indicator section D1.

Note that how an object X on the camera screen P1 appears to a user is identical to how the object X illustrated in (a) of FIG. 6 appears to the user.

(c) of FIG. 6 illustrates an example of a display on the display screen in a case where the mobile device 1 is further rotated to the right by 90° from the orientation illustrated in (b) of FIG. 6. In other words, the orientation of the mobile device 1 as illustrated in (c) of FIG. 6 is rotated to the right by 180° from the home orientation.

In this example also, it is still maintained how the buttons etc. are displayed on the display screen in the home orientation (as illustrated in (a) of FIG. 6). This causes the buttons etc. to be upside down with respect to the home orientation when the user looks at the mobile device 1.

(d) of FIG. 6 illustrates an example of a display on the display screen in a case where the mobile device 1 is further rotated to the right by 90° from the orientation illustrated in (c) of FIG. 6. That is, the orientation of the mobile device 1 as illustrated in (d) of FIG. 6 is rotated to the right by 270° from the home orientation. In other words, the orientation of the mobile device 1 as illustrated in (d) of FIG. 6 is rotated to the left by 90° when the user looks at the mobile device 1.

In this example also, it is still maintained how the buttons etc. are displayed on the display screen in the home orientation (as illustrated in (a) of FIG. 6). The mobile device 1 returns to the home orientation illustrated in (a) of FIG. 6 in a case where the mobile device 1 is rotated to the right by 90° from the orientation illustrated in (d) of FIG. 6.

(Functions and Effects)

As has been described, the mobile device 1 includes: a primary image capturing section 11 and a secondary image capturing section 12 for respectively generating a left-eye image and a right-eye image which are used to generate a stereoscopic image; an orientation determining section 13 for determining whether or not an orientation of the mobile device 1 is a home orientation in which the primary image capturing section 11 and the secondary image capturing section 12 can capture a left-eye image and a right-eye image, respectively; a sign drawing section 46 for displaying a sign on a display screen, a direction of which sign is recognizable; and a mode switching section 45 for switching between (i) a 2D image capturing mode in which the sign drawing section 46 changes the direction of the sign in accordance with the orientation of the mobile device 1 and (ii) a 3D image capturing mode in which the sign drawing section 46 causes a direction of the sign, which direction is displayed while the mobile device 1 is in the home orientation, to be maintained, the mode switching section 45 switching to the 3D image capturing mode in a case where the primary image capturing section 11 and the secondary image capturing section 12 capture a left-eye image and a right-eye image, respectively.

Therefore, such advantageous effects are brought about that it is possible to allow a user to recognize the orientation of the twin-lens image capturing device by use of a sign on the display screen in a case where the user attempts, in the 3D image capturing mode, to capture a stereoscopic image whose vertical and horizontal directions are distinct from each other.

(Modifications)

The following description will discuss preferred modifications of the mobile device 1.

[Issuance of Alert]

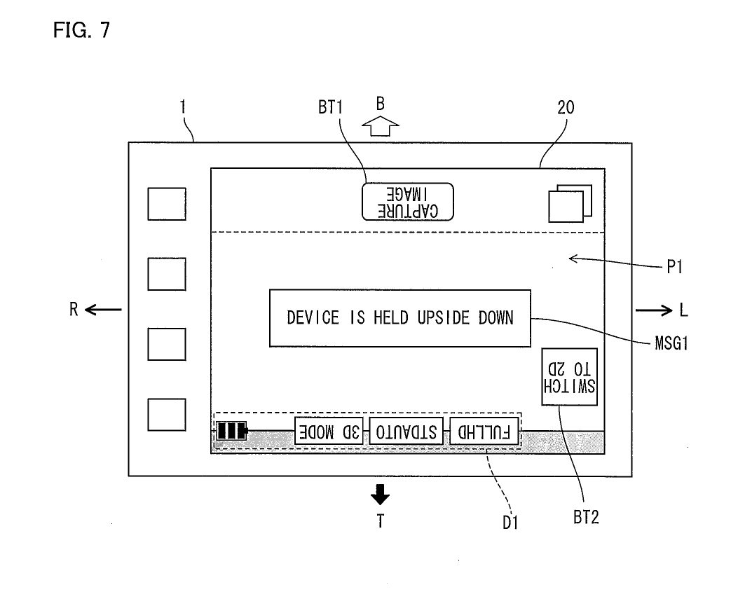

An example of how a text-based alert is issued will be described below with reference to FIG. 7. FIG. 7 is a view illustrating an example in which a text-based alert is issued in a case where the orientation of a mobile device 1 is upside down during the 3D image capturing mode.

As illustrated in FIG. 7, it is possible to issue, while the mobile device 1 is in the orientation illustrated in (c) of FIG. 6, a text-based alert (alert advice) MSG1 indicating that “the device is being held upside down.”

In this case, for example, the display control setting for the Still Image-3D-Message Display under “180° Rotation” is set to “Yes” (see FIG. 3).

The text-based alert issued as well as the upside-down buttons etc. thus allows a user to recognize that the user is holding the mobile device 1 upside down.

Note that, even in a case where the mobile device 1 is in the state illustrated in FIG. 7, it is more preferable that an image can be captured by pressing the image capturing button BT1. This is because there are situations in which a user intends to capture an inverted image while the mobile device 1 is being held upside down.

Note also that, it is still possible not to issue a text-based alert in a case where an inverted image is captured by pressing the image capturing button BT1 while the mobile device 1 is in the state illustrated in FIG. 7. This is due to likely situations in which a user knowingly captures such an inverted image while the user is holding the mobile device 1 upside down.

It is also possible to issue the text-based alert MSG1 again when (i) image capturing is ended or (ii) a predetermined length of time has elapsed after image capturing was ended.

Note that an alert can be the text-based alert MSG1 and/or a voice-based alert.

[Display on Display Screen while Video Image is Captured]

The description above has discussed the display on the display screen while a still image is being captured. Note, however, that the present embodiment is not limited to such. In fact, the same display is possible while a video image is being captured.

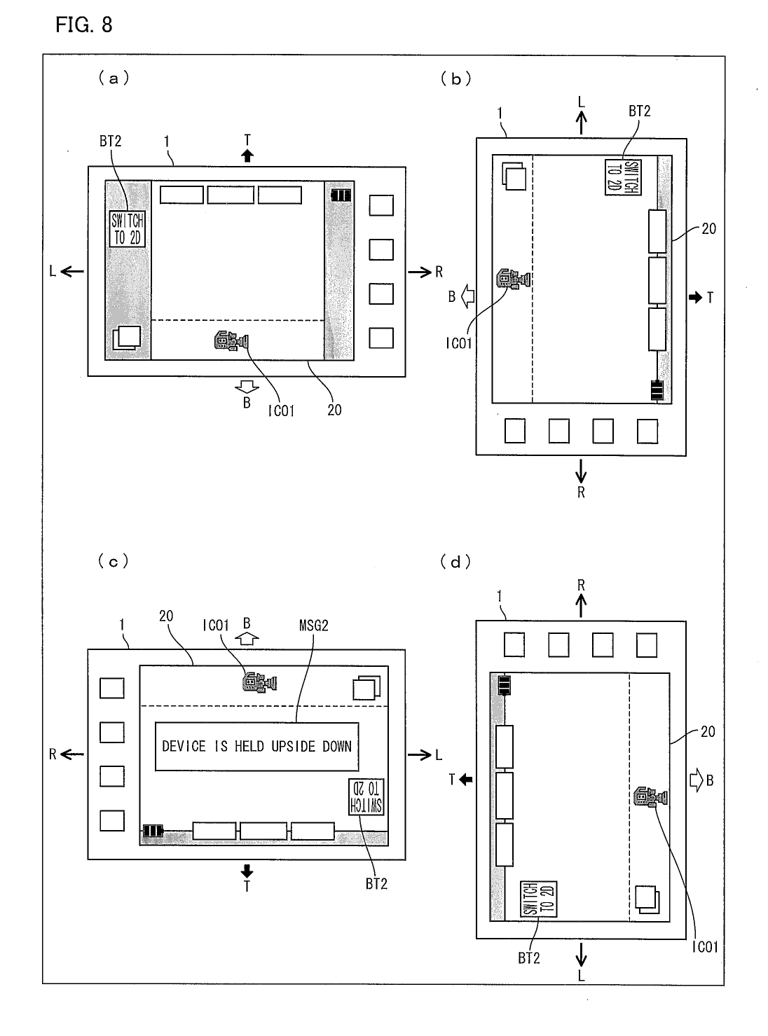

The following description will discuss, with reference to FIG. 8, examples of a display on a display screen while a video image is being captured in orientations of a mobile device 1. Note that the following description will discuss, as an example, a display on the display screen in a mode in which a 3D video image is captured. Therefore, the display control settings for Video Image-3D illustrated in FIG. 3 will be featured.

(a) of FIG. 8 illustrates an example of a display on the display screen while the mobile device 1 is in the home orientation.

The display screen of a touch panel display section 20 displays a video image capturing icon ICO1 and a 2D/3D mode switching button BT2.

The video image capturing icon ICO1 is an icon indicating that the mobile device 1 is in a video image capturing mode. The video image capturing icon ICO1 is located at a lower part of the display screen.

The 2D/3D mode switching button BT2 is used for switching, during video image capturing, between the 2D image capturing mode and the 3D image capturing mode. The 2D/3D mode switching button BT2 is located toward a left side of the display screen. The 2D/3D mode switching button BT2 shows, therein, a caption “Switch to 2D.”

Top, down, right, and left of the caption, which is shown in the 2D/3D mode switching button BT2, match top, down, right, and left (indicated by arrows T, B, R, and L illustrated in FIG. 8) of the mobile device 1.

The following description will discuss examples of a display on the display screen while the mobile device 1 is rotated from the home orientation. First, (b) of FIG. 8 illustrates an example of a display in a case where the mobile device 1 is rotated to the right by 90° from the home orientation.

In this example, it is still maintained how buttons etc. are displayed on the display screen in the home orientation (as illustrated in (a) of FIG. 8). This causes the buttons etc. to rotate to the right by 90° along with the rotation of the mobile device 1 when the user looks at the mobile device 1. The same principle applies to the indicator section indicator section D1.

Note that the video image capturing icon ICO1 is rotated on the display screen along with the rotation of the orientation of the mobile device 1 so that how the video image capturing icon ICO1 appears to the user remains the same.

Note also that, although not illustrated in (b) of FIG. 8 for convenience, it is possible to issue a text-based alert (alert advise) in accordance with the display control setting for Video Image-3D-Message Display under “Rightward 90° Rotation” (see FIG. 3) In addition, the text-based alert to be issued while the mobile device 1 is in the orientation illustrated in (b) of FIG. 8 (i) can be similar to a text-based alert MSG2 (described below) illustrated in (c) of FIG. 8 or (ii) can be a message indicating that “the mobile device 1 is in the orientation rotated by 90° from the home orientation.”

(c) of FIG. 8 illustrates an example of a display on the display screen in a case where the mobile device 1 is further rotated to the right by 90° from the orientation illustrated in (b) of FIG. 8. In other words, the mobile device 1 as illustrated in (c) of FIG. 8 is rotated by 180° from the home orientation.

In this example also, it is maintained how the buttons etc. are displayed in the home orientation (as illustrated in (a) of FIG. 8). This causes the buttons etc. to be upside down with respect to the home orientation when the user looks at the mobile device 1.

Note that the video image capturing icon ICO1 is rotated on the display screen along with the rotation of the orientation of the mobile device 1 so that how the video image capturing icon ICO1 appears to the user remains the same.

Note also that “Yes” is set for “180° Rotation” according to “Video Image-3D-Message Display” in the display control setting illustrated in FIG. 3. Accordingly, the text-based alert (alert advise) MSG2 is issued in the case where the mobile device 1 is in the orientation illustrated in (c) of FIG. 8. The content of the text-based alert MSG2 is similar to the text-based alert MSG1 described earlier.

(d) of FIG. 8 illustrates an example of a display on the display screen in a case where the mobile device 1 is further rotated to the right by 90° from the orientation illustrated in (c) of FIG. 8. That is, the orientation of the mobile device 1 as illustrated in (d) of FIG. 8 is rotated to the right by 270° from the home orientation. In other words, the orientation of the mobile device 1 as illustrated in (d) of FIG. 8 is rotated to the left by 90° from the home orientation.

In this example also, it is maintained how the 2D/3D mode switching button BT2 is displayed on the display screen while the mobile device 1 is in the home orientation (as illustrated in (a) of FIG. 8).

Note that the video image capturing icon ICO1 is rotated on the display screen along with the rotation of the orientation of the mobile device 1 so that how the video image capturing icon ICO1 appears to the user remains the same.

The mobile device 1 returns to the home orientation illustrated in (a) of FIG. 8 in a case where the mobile device 1 is rotated to the right by 90° from the orientation illustrated in (d) of FIG. 8.

[Modifications of where to Display Buttons Etc.]

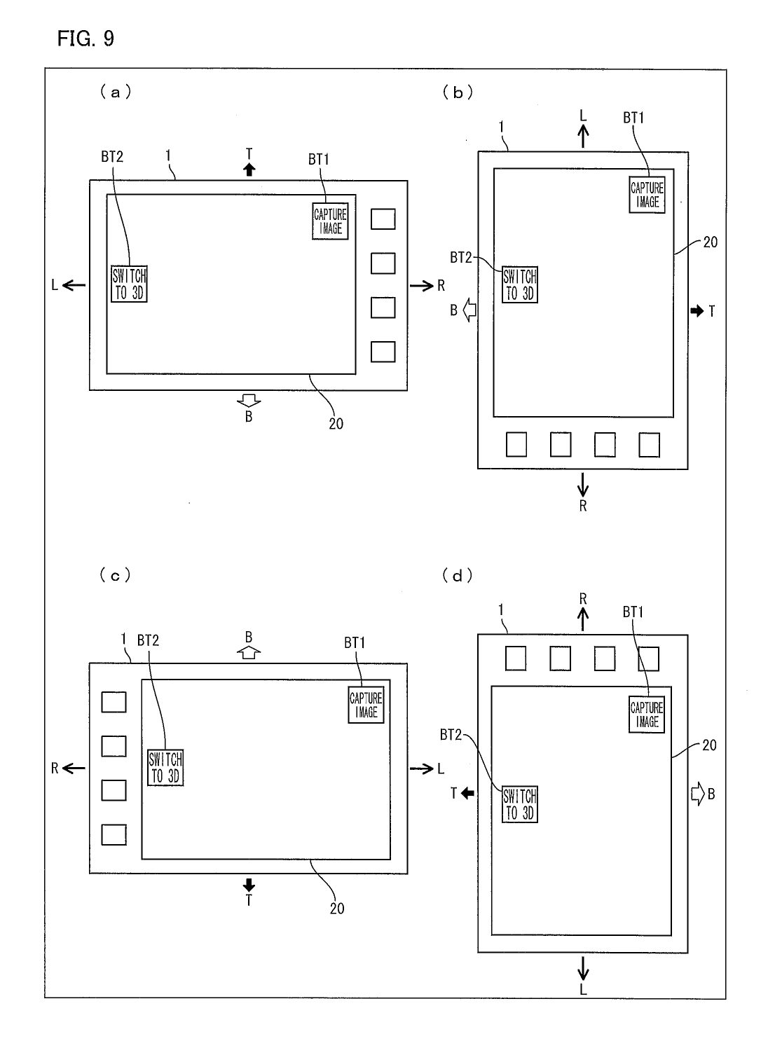

The following description will discuss, with reference to FIGS. 9 through 12, preferred modifications of locations at which buttons etc. drawn by the sign drawing section 46 are to be displayed.

Note that FIGS. 9 through 12 are intended for the description of the locations at which to display the buttons etc. Therefore, the illustration of a text-based alert will be omitted from each of FIGS. 9 through 12 for the sake of simplicity.

[1] Case of 2D Image Capturing Mode

The following description will discuss, with reference to FIG. 9, the modification of locations where the buttons etc. are displayed in the 2D image capturing mode.

Note that, for convenience, the illustration of a camera screen P1 and an indicator section D1 is omitted from FIG. 9. Note also that, in the description below, “Rotate” is set for the Still Image-2D-Icon Display under “180° Rotation” in the display control setting illustrated in FIG. 3.

According to the present modification, the sign drawing section 46, regardless of the orientation of a mobile device 1, (i) causes an image capturing button BT1 to be located at an upper right part of a display screen when the user looks at the mobile device 1 and (ii) causes captions to be in the same direction when the user looks at the mobile device 1. The present modification will be described in detail below with reference to (a) through (d) of FIG. 9.

(a) of FIG. 9 illustrates an example of a display on the display screen in a case where the mobile device 1 as illustrated in (a) of FIG. 9 is in the home orientation.

The display screen of the touch panel display section 20 displays the image capturing button BT1 and a 2D/3D mode switching button BT2.

The caption shown in the image capturing button BT1 and the caption shown in the 2D/3D mode switching button BT2 are, for example, “Capture Image” and “Switch to 3D”, respectively.

In so doing, top, down, right, and left of each caption, which is shown in the image capturing button BT1 and the 2D/3D mode switching button BT2, match top, down, right, and left (indicated by arrows T, B, R, and L illustrated in FIG. 9) of the mobile device 1.

Note that (i) the image capturing button BT1 is located at the upper right part of the display screen and (ii) the 2D/3D mode switching button BT2 is located at a middle left part of the display screen.

Since the image capturing button BT1 is thus located at the upper right part of the display screen when the user looks at the mobile device 1, the user can easily touch the image capturing button BT1 while the user is operating the mobile device 1 with his/her right hand. Needless to say, the location of the image capturing button BT1 is not limited to such, but can be the opposite of how it is described above so that the user can easily touch the image capturing button BT1 while operating the mobile device 1 with his/her left hand. Furthermore, the mobile device 1 can be configured so that the location of the image capturing button BT1 can be switched from side to side by a user setting.

The following description will discuss examples of a display on the display screen in a case where the orientation of the mobile device 1 is rotated from the home orientation. (b) of FIG. 9 illustrates an example of a display on the display screen in a case where the mobile device 1 is rotated to the right by 90° from the home orientation.

In this example, the directions of the buttons etc. on the display screen are rotated so that the directions of the captions remain the same when the user looks at the mobile device 1. Specifically, the directions of the respective captions, which are shown in the image capturing button BT1 and the 2D/3D mode switching button BT2, are rotated.

The image capturing button BT1 is located at an upper right part of the display screen when the user looks at the mobile device 1. The 2D/3D mode switching button BT2 is located at a middle left part of the display screen when the user looks at the mobile device 1.

Even in a case where the orientation of the mobile device 1 is thus rotated to the right by 90°, it does not change how the image capturing button BT1 and the 2D/3D mode switching button BT2 are located in relation to each other when the user looks at the mobile device 1. This allows the user to easily touch the image capturing button BT1 while operating the mobile device 1 with his/her right hand.

(c) of FIG. 9 illustrates an example of a display on the display screen in a case where the mobile device 1 is further rotated to the right by 90° from the orientation illustrated in (b) of FIG. 9. Specifically, the orientation of the mobile device 1 as illustrated in (c) of FIG. 9 is rotated to the right by 180° from the home orientation. The downward direction (indicated by the arrow B) of the mobile device 1 orients upwards in this view.

In so doing, the direction of the buttons etc. of the presentation are rotated in accordance with “Rotate” which is the display control setting for the Still Image-2D-Icon Display under “180° Rotation.”

The image capturing button BT1 is located at an upper right part of the display screen when the user looks at the mobile device 1. The 2D/3D mode switching button BT2 is located at a middle left part of the display screen when the user looks at the mobile device 1.

(d) of FIG. 9 illustrates an example of a display on the display screen in a case where the mobile device 1 is further rotated to the right by 90° from the orientation illustrated in (c) of FIG. 9. That is, the orientation of the mobile device 1 as illustrated in (d) of FIG. 9 is rotated to the right by 270° from the home orientation. In other words, the orientation of the mobile device 1 as illustrated in (d) of FIG. 9 is rotated to the left by 90° from the home orientation.

In so doing, the directions of the buttons etc. are rotated in accordance with “Rotate” which is the display control setting for the Still Image-2D-Icon Display under “Leftward 90° Rotation” (see FIG. 3).

Specifically, the directions of the respective captions, which are shown in the image capturing button BT1 and the 2D/3D mode switching button BT2, are rotated so that the directions of the captions remain the same when the user looks at the mobile device 1.

The image capturing button BT1 is located at an upper right part of the display screen when the user looks at the mobile device 1. The 2D/3D mode switching button BT2 is located at a middle left part of the display screen when the user looks at the mobile device 1.

The mobile device 1 returns to the home orientation illustrated in (a) of FIG. 9 in a case where the mobile device 1 is rotated to the right by 90° from the orientation illustrated in (d) of FIG. 9.

According to the present modification, the image capturing button BT1 is located at the upper right part of the display screen when the user looks at the mobile device 1, regardless of the orientation of the mobile device 1. This allows the user to easily touch the image capturing button BT1 while operating the mobile device 1 with his/her right hand.

[2] Case of 3D Image Capturing Mode

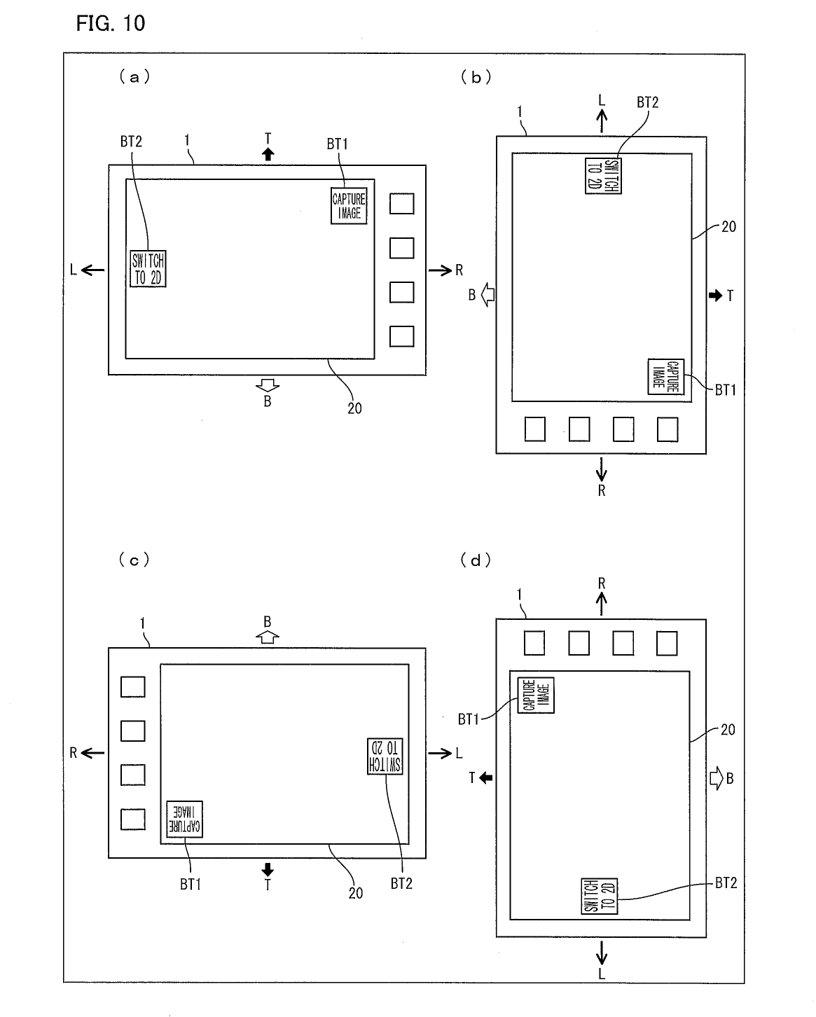

Modifications 1 through 3, in each of which locations where the buttons etc. are displayed in the 3D image capturing mode are modified, will be described below with reference to FIGS. 10 through 12, respectively.

[Modification 1]

Modification 1 will describe, with reference to FIG. 10, an example in which a mobile device 1 is configured with the aim of facilitating an operation while a mobile device 1 is in the home orientation. FIG. 10 is a view illustrating Modification 1 of a display on a display screen in cases where the mobile device 1 is in different orientations while in the 3D image capturing mode. Note that, for convenience, the illustration of a camera screen P1 and an indicator section D1 is omitted from FIG. 10.

According to Modification 1, a sign drawing section 46 (i) causes an image capturing button BT1 to be located at an upper right part of the display screen from a user's perspective in a case where the mobile device 1 is in the home orientation and (ii) causes the location of the image capturing button BT1 in the home orientation to be maintained, regardless of the orientation of the mobile device 1. Modification 1 will be described in detail below with reference to (a) through (d) of FIG. 10.

(a) of FIG. 10 illustrates an example of a display on the display screen in a case where the mobile device 1 is in the home orientation. As illustrated in (a) of FIG. 10, the display screen of the touch panel display section 20 displays the image capturing button BT1 and the 2D/3D mode switching button BT2.

A caption shown in the image capturing button BT1 and a caption shown in the 2D/3D mode switching button BT2 are, for example, “Capture Image” and “Switch to 3D”, respectively.

In this example, top, down, right, and left of each caption, which is shown in the image capturing button BT1 and the 2D/3D mode switching button BT2, match top, down, right, and left (indicated by arrows T, B, R, and L illustrated in FIG. 10) of the mobile device 1.

The image capturing button BT1 and the 2D/3D mode switching button BT2 are located as illustrated in (a) of FIG. 9. Specifically, (i) the image capturing button BT1 is located at an upper right part of the display screen and (ii) the 2D/3D mode switching button BT2 is located at a middle left part of the display screen.

Since the image capturing button BT1 is thus located at the upper right part of the display screen when the user looks at the mobile device 1, the user can easily touch the image capturing button BT1 while operating the mobile device 1 with his/her right hand.

The following description will discuss examples of a display on the display screen in a case where the orientation of the mobile device 1 is rotated from the home orientation. (b) of FIG. 10 illustrates an example of a display on the display screen in a case where the mobile device 1 is rotated to the right by 90° from the home orientation.

In this example, it is maintained how the buttons etc. are displayed on the display screen in the home orientation (as illustrated in (a) of FIG. 10). This causes the buttons etc. to be rotated to the right by 90° along with the rotation of the mobile device 1 when the user looks at the mobile device 1. That is, the image capturing button BT1 is located at a lower right part of the display screen when the user looks at the mobile device 1.

(c) of FIG. 10 illustrates an example of a display on the display screen in a case where the mobile device 1 is further rotated to the right by 90° from the orientation illustrated in (b) of FIG. 10. In other words, the orientation of the mobile device 1 as illustrated in (c) of FIG. 10 is rotated to the right by 180° from the home orientation.

In this example also, it is maintained how the buttons etc. are displayed on the display screen in the home orientation (as illustrated in (a) of FIG. 10). This causes the buttons etc. to be upside down with respect to the home orientation when the user looks at the mobile device 1. That is, the image capturing button BT1 is located at a lower left part of the display screen when the user looks at the mobile device 1.

(d) of FIG. 10 illustrates an example of a display on the display screen in a case where the mobile device 1 is further rotated to the right by 90° from the orientation illustrated in (c) of FIG. 10. That is, the orientation of the mobile device 1 as illustrated in (d) of FIG. 10 is rotated to the right by 270° from the home orientation. In other words, the orientation of the mobile device 1 as illustrated in (d) of FIG. 10 is rotated to the left by 90° from the home orientation.

In this example also, it is maintained how the buttons etc. are displayed on the display screen in the home orientation (as illustrated in (a) of FIG. 10). That is, the image capturing button BT1 is located at an upper left part of the display screen when the user looks at the mobile device 1.

The mobile device 1 returns to the home orientation illustrated in (a) of FIG. 10 in a case where the mobile device 1 is rotated to the right by 90° from the orientation illustrated in (d) of FIG. 10.

According to Modification 1, the image capturing button BT1 is located at the upper right part of the display screen while the mobile device 1 is in the home orientation. This allows a user to easily touch the image capturing button BT1 while the mobile device 1 is in the home orientation.

While the mobile device 1 is not in the home orientation, it becomes harder for the user to operate the mobile device 1 with his/her right hand than it is while the mobile device 1 is in the home orientation. This makes it obvious to the user when the mobile device 1 is not in the home orientation.

[Modification 2]

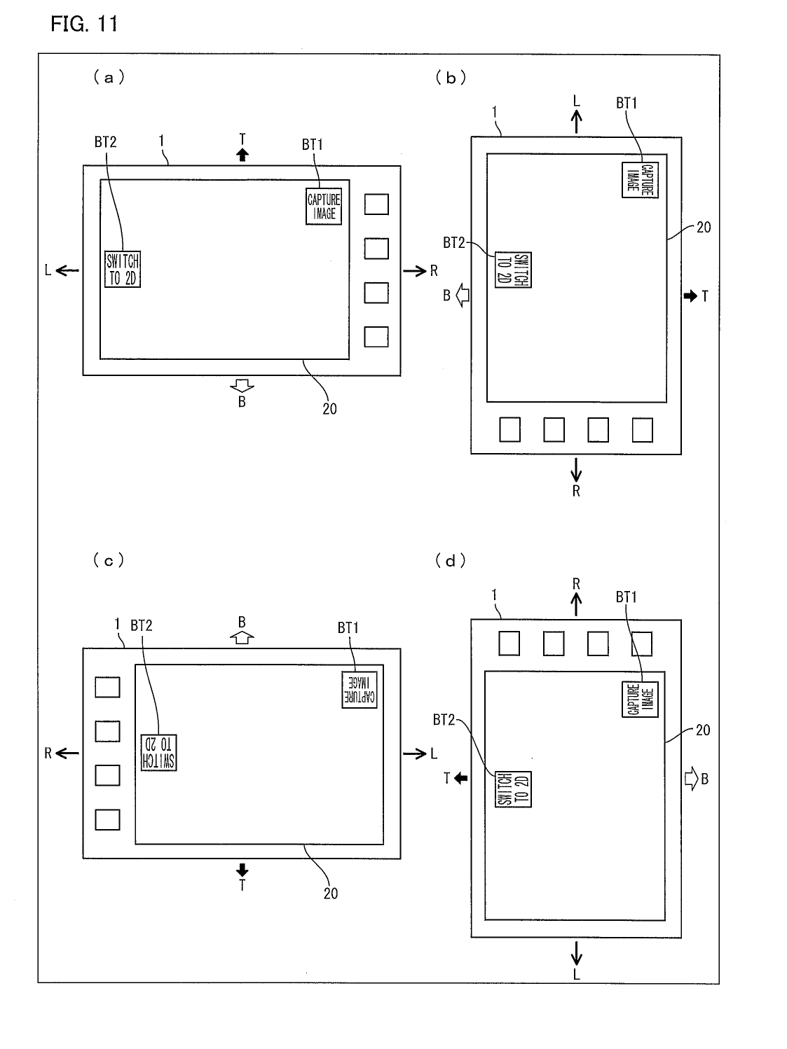

Modification 2 will describe, with reference to FIG. 11, examples in which a mobile device 1 is configured with the aim of facilitating an operation of a mobile device 1 in different orientations. FIG. 11 is a view illustrating Modification 2 of a display on the display screen in cases where the mobile device 1 is in the different orientations while in the 3D image capturing mode. Note that, for convenience, the illustration of a camera screen P1 and an indicator section D1 is omitted from FIG. 11.

According to Modification 2, a sign drawing section 46 (i) causes an image capturing button BT1 to be located at an upper right part of a display screen when the user looks at the mobile device 1, regardless of the orientation of the mobile device 1 and (ii) maintains how a caption shown in the image capturing button BT1 is directed in the home orientation. In other words, the sign drawing section 46 (a) changes, according to the orientation of the mobile device 1, how the image capturing button BT1 is actually located on the display screen of the touch panel display 20 and (b) maintains how the caption shown in the image capturing button BT1 is directed in the home orientation.

Modification 2 will be described in detail below with reference to (a) through (d) of FIG. 11.

(a) of FIG. 11 illustrates an example of a display on the display screen on the display screen in a case where the mobile device 1 is in the home orientation. (a) of FIG. 11 is similar to (a) of FIG. 10 in terms of (i) the contents of captions shown in an image capturing button BT1 and a 2D/3D mode switching button BT2 and (ii) the locations of the image capturing button BT1 and the 2D/3D mode switching button BT2. Therefore, descriptions of the contents and the locations will be omitted in Modification 2.

The following description will discuss examples of a display on the display screen in a case where the orientation of the mobile device 1 is rotated from the home orientation. (b) of FIG. 11 illustrates an example of a display on the display screen in a case where the mobile device 1 is rotated to the right by 90° from the home orientation.

In this example, it is still maintained how the image capturing button BT1 and the 2D/3D mode switching button BT2 are directed in the home orientation (as illustrated in (a) of FIG. 11). This causes the buttons etc. to rotate to the right by 90° along with the rotation of the mobile device 1 when the user looks at the mobile device 1.

Meanwhile, the image capturing button BT1 and the 2D/3D mode switching button BT2 are displayed so that their respective locations in relation to each other remain the same as those in the home orientation when the user looks at the mobile device 1. Specifically, when the user looks at the mobile device 1, the image capturing button BT1 is located at an upper right part of the display screen whereas the 2D/3D mode switching button BT2 is located at a middle left part of the display screen from.

Even in a case where the orientation of the mobile device 1 is thus rotated to the right by 90°, it does not change how the image capturing button BT1 and the 2D/3D mode switching button BT2 are located in relation to each other when the user looks at the mobile device 1. This allows the user to easily touch the image capturing button BT1 while operating the mobile device 1 with his/her right hand.

(c) of FIG. 11 illustrates an example of a display on the display screen in a case where the mobile device 1 is further rotated to the right by 90° from the orientation illustrated in (b) of FIG. 11. Specifically, the orientation of the mobile device 1 as illustrated in (c) of FIG. 11 is rotated to the right by 180° from the home orientation.

In this example also, it is still maintained how the image capturing button BT1 and the 2D/3D mode switching button BT2 are directed in the home orientation (as illustrated in (a) of FIG. 11).

As a result, the directions of the image capturing button BT1 and the 2D/3D mode switching button BT2 appear, to the user, upside down with respect to those in the home orientation.

Meanwhile, the image capturing button BT1 and the 2D/3D mode switching button BT2 are displayed so that their respective locations in relation to each other remain the same as those in the home orientation when the user looks at the mobile device 1. Specifically, when the user looks at the mobile device 1, the image capturing button BT1 is located at an upper right part of the display screen whereas the 2D/3D mode switching button BT2 is located at a middle left part of the display screen.

(d) of FIG. 11 illustrates an example of a display on the display screen in a case where the mobile device 1 is further rotated to the right by 90° from the orientation illustrated in (c) of FIG. 11. That is, the orientation of the mobile device 1 as illustrated in (d) of FIG. 11 is rotated to the right by 270° from the home orientation. In other words, the orientation of the mobile device 1 as illustrated in (d) of FIG. 11 is rotated to the left by 90° from the home orientation.

In this example also, it is still maintained how the image capturing button BT1 and the 2D/3D mode switching button BT2 are directed in the home orientation (as illustrated in (a) of FIG. 11).

Meanwhile, the image capturing button BT1 and the 2D/3D mode switching button BT2 are displayed so that their respective locations in relation to each other remain the same as those in the home orientation when the user looks at the mobile device 1. Specifically, when the user looks at the mobile device 1, the image capturing button BT1 is located at an upper right part of the display screen whereas the 2D/3D mode switching button BT2 is located at a middle left part of the display screen.

The mobile device 1 returns to the home orientation illustrated in (a) of FIG. 11 in a case where the mobile device 1 is rotated to the right by 90° from the orientation illustrated in (d) of FIG. 11.

According to Modification 3, the image capturing button BT1 is located at an upper right part of the display screen in each of the orientations of the mobile device 1 when the user looks at the mobile device 1. This allows the user to easily touch the image capturing button BT1 with his/her right hand in each of the orientations of the mobile device 1.

[Modification 3]

Modification 3 will describe, with reference to FIG. 12, examples in which an image capturing button BT1 is displayed at the same location on a display screen, regardless of the orientation of a mobile device 1, whether the location is viewed from a user's perspective or from a perspective of a sign drawing section 46 which draws the image capturing button BT1. FIG. 12 is a view illustrating Modification 3 of a display on the display screen of a touch panel display section 20 in cases where the mobile device 1 is in the different orientations while in the 3D image capturing mode. Note that, for convenience, the illustration of a camera screen P1 and an indicator section D1 is omitted from FIG. 12.

According to Modification 3, the sign drawing section 46 (i) causes the image capturing button BT1 to be located at a center part of the display screen, regardless of the orientation of the mobile device 1 and (ii) maintains how an direction of a caption shown in the image capturing button BT1 is directed in the home orientation. Modification 3 will be described in detail below with reference to (a) through (d) of FIG. 12.

(a) of FIG. 12 illustrates an example of a display on the display screen in a case where the mobile device 1 is in the home orientation. As illustrated in (a) of FIG. 12, the display screen displays the image capturing button BT1 and a 2D/3D mode switching button BT2.

The caption shown in the image capturing button BT1 and a caption shown in the 2D/3D mode switching button BT2 are, for example, “Capture Image” and “Switch to 3D”, respectively.

In so doing, top, down, right, and left of each caption, which is shown in the image capturing button BT1 and the 2D/3D mode switching button BT2, match top, down, right, and left (indicated by arrows T, B, R, and L illustrated in FIG. 12) of the mobile device 1.

The image capturing button BT1 is located at the center part of the display screen. The 2D/3D mode switching button BT2 is located at a middle left part of the display screen.

The following description will discuss examples of a display on the display screen in a case where the orientation of the mobile device 1 is rotated from the home orientation. (b) of FIG. 12 illustrates an example of a display on the display screen in a case where the mobile device 1 is rotated to the right by 90° from the home orientation.

In this example, it is maintained how the respective captions, which are shown in the image capturing button BT1 and the 2D/3D mode switching button BT2, are directed in the home orientation (as illustrated in (a) of FIG. 12). This causes the captions to be rotated to the right by 90° along with the rotation of the mobile device 1 when the user looks at the mobile device 1.

Meanwhile, the image capturing button BT1 and the 2D/3D mode switching button BT2 are displayed so that their respective locations in relation to each other remain the same as those in the home orientation when the user looks at the mobile device 1. Specifically, the image capturing button BT1 is located at a center part of the display screen when the user looks at the mobile device 1.

More specifically, the sign drawing section 46 causes the image capturing button BT1 to be located at the same part of the display screen as in the home orientation.

In addition, the 2D/3D mode switching button BT2 is located at a middle left part of the display screen when the user looks at the mobile device 1.

(c) of FIG. 12 illustrates an example of a display on the display screen in a case where the mobile device 1 is further rotated to the right by 90° from the orientation illustrated in (b) of FIG. 12. Specifically, the orientation of the mobile device 1 as illustrated in (c) of FIG. 12 is rotated to the right by 180° from the home orientation.

In this example also, it is still maintained how the image capturing button BT1 and the 2D/3D mode switching button BT2 are directed in the home orientation (as illustrated in (a) of FIG. 12).

As a result, the directions of the image capturing button BT1 and the 2D/3D mode switching button BT2 appear, to the user, upside down with respect to those in the home orientation.

Meanwhile, the image capturing button BT1 and the 2D/3D mode switching button BT2 are displayed so that their respective locations in relation to each other remain the same as those in the home orientation when the user looks at the mobile device 1. Specifically, when the user looks at the mobile device 1, the image capturing button BT1 is located at an upper right part of the display screen whereas the 2D/3D mode switching button BT2 is located at a middle left part of the display screen.

More specifically, the sign drawing section 46 causes the image capturing button BT1 to be located at the same part of the display screen as in the home orientation.

(d) of FIG. 12 illustrates an example of a display on the display screen in a case where the mobile device 1 is further rotated to the right by 90° from the orientation illustrated in (c) of FIG. 12. That is, the orientation of the mobile device 1 as illustrated in (d) of FIG. 12 is rotated to the right by 270° from the home orientation. In other words, the orientation of the mobile device 1 as illustrated in (d) of FIG. 12 is rotated to the left by 90° from the home orientation.

In this example also, it is still maintained how the image capturing button BT1 and the 2D/3D mode switching button BT2 are directed in the home orientation (as illustrated in (a) of FIG. 12).

Meanwhile, the image capturing button BT1 and the 2D/3D mode switching button BT2 are displayed so that their respective locations in relation to each other remain the same as those in the home orientation when the user looks at the mobile device 1. Specifically, when the user looks at the mobile device 1, the image capturing button BT1 is located at an upper right part of the display screen whereas the 2D/3D mode switching button BT2 is located at a middle left part of the display screen.

To be more specific, the sign drawing section 46 causes the image capturing button BT1 to be located at the same part of the display screen as in the home orientation.

The mobile device 1 returns to the home orientation illustrated in (a) of FIG. 12 in a case where the mobile device 1 is rotated to the right by 90° from the orientation illustrated in (d) of FIG. 12.

According to Modification 4, the image capturing button BT1 is located at the same part of the display screen when the user looks at the mobile device 1, regardless of the orientation of the mobile device 1. Furthermore, the sign drawing section 46 causes the image capturing button BT1 to be located at the same part of the display screen as in the home orientation, regardless of the orientation of the mobile device 1.

[Other Modifications]

Note that it is possible to modify Modifications 1 through 3 as follows. That is, a text-based alert, which indicates that the orientation of the mobile device 1 is upside down, can be issued while the mobile device 1 is in the orientations illustrated in (c) of FIG. 10, (c) of FIG. 11, and (c) of FIG. 12.

Additionally, the following configurations can be considered in cases where (i) the Modifications 1 through 3 are applied in the 2D image capturing mode and (ii) Modification 1 is applied in the 3D image capturing mode.

That is, in a case where a user switches from one image capturing mode to the other by pressing the 2D/3D mode switching button BT2 while the mobile device 1 is in the orientation illustrated in (c) of FIG. 9, the display screen turn into a state illustrated in (c) of FIG. 10.

In this case, the 2D/3D mode switching button BT2 is located, when the user looks at the mobile device 1, (i) at a middle left part of the display screen before the switching and (ii) at a middle right part of the display screen after the switching.

Therefore, in a case where the user attempts to switch back to the 2D image capturing mode from the 3D image capturing mode, there is a possibility that the user finds it difficult to recognize the location of the 2D/3D mode switching button BT2.

For a smoother transition in such switching between the image capturing modes, the configuration of the mobile device 1 can be modified as follows.

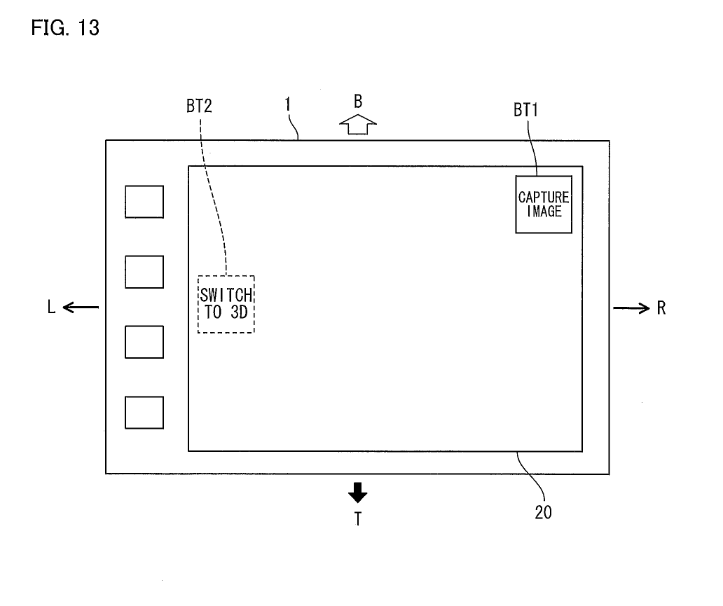

First, after the switching between the image capturing modes, a change in the location of the 2D/3D mode switching button BT2 can be indicated by, for example, graying out the 2D/3D mode switching button BT2 as illustrated in FIG. 13 (the grayed out 2D/3D mode switching button BT2 is indicated by dotted lines in FIG. 13). As an alternative, it is also possible to disable the image capturing modes switching carried out by pressing the 2D/3D mode switching button BT2.

As another alternative, it is possible to switch between the image capturing modes by, besides pressing of the 2D/3D mode switching button BT2, a flicking gesture or the like on the touch panel display section 20. As a further alternative, it is possible to switch between the image capturing modes by causing the orientation determining section 13 to detect a change in orientation of the mobile device 1.

As has been described, a mobile device 1 includes: a primary image capturing section 11 and a secondary image capturing section 12 for respectively generating a left-eye image and a right-eye image which are used to generate a stereoscopic image; an orientation determining section 13 for determining whether or not an orientation of the mobile device 1 is a home orientation in which the primary image capturing section 11 and the secondary image capturing section 12 can capture a left-eye image and a right-eye image, respectively; a sign drawing section 46 for displaying a sign on a display screen, a direction of which sign is recognizable; and a mode switching section 45 for switching between (i) a 2D image capturing mode in which the sign drawing section 46 changes the direction of the sign in accordance with the orientation of the mobile device 1 and (ii) a 3D image capturing mode in which the sign drawing section 46 causes a direction of the sign, which direction is displayed while the mobile device 1 is in the home orientation, to be maintained, the mode switching section 45 switching to the 3D image capturing mode in a case where the primary image capturing section 11 and the secondary image capturing section 12 capture a left-eye image and a right-eye image, respectively.

This allows a user to recognize, in a case where the user attempts to capture a stereoscopic image whose vertical and horizontal directions are distinct from each other, the orientation of the mobile device 1 by use of the sign on the display screen.

It is preferable to configure a twin-lens image capturing device of the present invention such that, in the orientation maintaining mode, the sign displaying means changes, in accordance with the orientation of the twin-lens image capturing device, a location on the display screen at which location the sign is displayed.

According to the configuration, the location of the sign is changed according to the orientation of the twin-lens image capturing device. For example, the twin-lens image capturing device is preferably configured so that an actual location on the display screen, at which actual location the sign is displayed, changes according to the orientation of the twin-lens image capturing device, whereas a relative location of the sign from the user's perspective does not change. For example, the actual location of the sign can be a center part of the display screen. Alternatively, the sign can be displayed so that a user can spot the sign at an upper right part of the display screen from the user's perspective, regardless of the orientation of the twin-lens image capturing device. Such a configuration causes the sign to remain at the same location on the display screen from the user's perspective, regardless of the orientation of the twin-lens image capturing device. With such a configuration, it is therefore possible to increase the practicality in operation of the twin-lens image capturing device in a case where the sign serves as a soft key for instructing the operation.

As a result of the configuration, it is possible to display the sign at a location where a user can easily spot the sign.

It is preferable to configure the twin-lens image capturing device of the present invention such that, in the orientation maintaining mode, the sign displaying means causes a location on the display screen, at which location the sign is displayed while the twin-lens image capturing device is in the regular orientation, to be maintained even in a case where the orientation determining means determines that the twin-lens image capturing device is not in the regular orientation.

According to the configuration, the location at which the sign is displayed while the twin-lens image capturing device is in the regular orientation is maintained even in a case where the twin-lens image capturing device is not in the regular orientation.

This causes the location of the sign from a user's perspective to be changed according to the orientation of the twin-lens image capturing device, and therefore allows the user to easily recognize the orientation of the twin-lens image capturing device.

It is preferable that the twin-lens image capturing device of the present invention further includes: alerting means for issuing, in a case where the twin-lens image capturing device is upside down when instructing the first and second image capturing sections to respectively capture a right-eye image and a left-eye image, an alert indicating that the twin-lens image capturing device is upside down, which alert is issued in an orientation in accordance with the orientation of the twin-lens image capturing device.

According to the configuration, the alert is issued in an orientation according to the orientation of the twin-lens image capturing device. The orientation of the alert is, for example, an orientation of text.

Therefore, in a case where a message is to be communicated to a user, it is possible to communicate the message that is easy for the user to recognize even in a case where the twin-lens image capturing device is upside down.

It is preferable that the twin-lens image capturing device of the present invention further includes: planar image capturing means for capturing a planar image by use of one of the first and second image capturing sections, the mode switching means switching to the orientation following mode in a case where the planar image capturing means captures a planar image.

With the configuration, it is possible to properly configure a twin-lens image capturing device capable of capturing an image in so-called 2D mode and 3D mode. Examples of the twin-lens image capturing device encompass twin-lens digital cameras, high performance mobile phone (i.e. smartphones), and tablet devices.

It is preferable to configure the twin-lens image capturing device of the present invention such that the sign displayed by the sign displaying means includes a sign for instructing the first and second image capturing sections to capture a right-eye image and a left-eye image, respectively.

According to the configuration, a sign included in the sign displayed by the sign displaying means is a soft key for instructing the twin-lens camera to capture a stereoscopic image. This allows a soft key to be more convenient.

It is preferable to configure the twin-lens image capturing device of the present invention such that the sign displayed by the sign displaying means includes a sign for instructing the mode switching means to switch between the orientation following mode and the orientation maintaining mode.

According to the configuration, a sign included in the sign displayed by the sign displaying means is a soft key for, for example, switching between the 2D mode and the 3D mode. This allows a soft key to be more convenient.

It is preferable to configure the twin-lens image capturing device of the present invention such that: the sign displayed by the sign displaying means includes a sign for instructing the mode switching means to switch between the orientation following mode and the orientation maintaining mode; and in a case where the twin-lens image capturing device is upside down while in the orientation following mode, the mode switching means carries out at least one of (i) issuance of an alert indicating that the twin-lens image capturing device is upside down and (ii) prohibition of switching to the orientation maintaining mode.

Note that there are cases where the twin-lens image capturing device is held upside down when a switch is made from the orientation following mode, in which vertical and horizontal directions are not distinct from each other, to the orientation maintaining mode, in which the vertical and horizontal directions are distinct from each other.

With the configuration, it is possible to alert a user, in such cases, by displaying a message indicating that the twin-lens image capturing device is upside down. With the configuration, it is also possible, in such cases, to even prevent the twin-lens image capturing device from being held upside down.

Hence, it is possible to allow for a smoother transition in switching between the modes.

[Method of Realization of Each Block]

The blocks of the mobile device 1 described above can each be (i) realized by means of hardware by use of logic circuits provided on an integrated circuit (IC chip) or (ii) realized by means of software by use of a CPU (Central Processing Unit).

In the latter case, the blocks each include (i) a CPU for executing a command of a program for achieving a function, (ii) a ROM (Read Only Memory) for storing the program, (i) a RAM (Random Access Memory) for extracting the program, (iv) a storage device (storage medium) such as a memory for storing the program and various data, and the like. The object of the present invention can also be attained by (i) providing a storage medium in each of the blocks, the storage medium having stored (in a computer-readable manner) program codes (executable program, intermediate code program, and source program) of a control program which is a piece of software for achieving the function of each of the blocks and (ii) causing a computer (or CPU or MPU) to read out and then execute the program codes thus stored in the storage medium.

Examples of the storage medium encompass (i) tapes such as a magnetic tape and a cassette tape, (ii) disks including magnetic disks such as a floppy disk (Registered Trademark) and a hard disk and optical disks such as a CD-ROM, an MO, an MD, a DVD, a CD-R, and a Blu-ray Disk (registered trademark), (iii) cards such as an IC card (including a memory card) and an optical card, (iv) semiconductor memories such as a mask ROM, an EPROM, an EEPROM, and a flash ROM, and (v) logic circuits such as a PLD (Programmable logic device) and an FPGA (Field Programmable Gate Array).

Furthermore, the blocks can each be configured to be connectable to a communications network so as to be provided with the program code via the communications network. The communications network is not limited to any particular one, provided that the program code can be transmitted via the communications network. Examples of the communications network encompass the Internet, an intranet, an extranet, a LAN, an ISDN, a VAN, a CATV communications network, a virtual dedicated network (virtual private network), a telephone line network, a mobile communications network, and a satellite communications network. A transfer medium for configuring the communications network need only be a medium via which the program code can be transmitted, and is not limited to any particular configuration or any type. Examples of the transfer medium encompass (i) wired lines such as IEEE 1394, a USB, an electric power line, a cable TV line, a telephone line, and an ADSL (Asymmetric Digital Subscriber Line) and (ii) wireless communications such as an infrared radiation (e.g. IrDA and remote control), Bluetooth (Registered Trademark), IEEE 802.11 wireless, HDR (High Data Rate), NFC (Near Field Communication), DLNA (Digital Living Network Alliance), a mobile telephone network, a satellite line, and a terrestrial digital network. Note that the present invention encompasses transmission of a computer data signal which is (i) embodied by electronic transmission of the program code and (ii) incorporated in a carrier wave.

### INDUSTRIAL APPLICABILITY

The present invention is applicable to a smartphone and the like which includes (i) a twin-lens camera section and (ii) a touch panel display section.

### REFERENCE SIGNS LIST

1 Mobile device (twin-lens image capturing device)
10 Twin-lens camera section (first and second image capturing sections)
11 Primary image capturing section (image capturing section)
12 Secondary image capturing section (image capturing section)
13 Orientation determining section (orientation determining means)
20 Touch panel display section (sign displaying means)
21 Operation section
22 Display section (sign displaying means)
40 Control section
41 Image capturing control section
42 3D image capturing control section
43 2D image capturing controlling section (planar image capturing means)
45 Image capturing mode switching control section (mode switching means)
46 Sign drawing section (sign displaying means, alerting means)
47 Image display control section
50 Control section
D1 Indicator section (sign)
BT1 Image capturing button (sign)
BT2 2D/3D mode switching button BT2 (sign)
MSG1, MSG2 Alert (alert advise)

1. A twin-lens image capturing device, comprising:
first and second image capturing sections for respectively generating a right-eye image and a left-eye image which are used to generate a stereoscopic image;
orientation determining means for determining whether or not an orientation of the twin-lens image capturing device is a regular orientation in which the first and second image capturing sections can capture a right-eye image and a left-eye image, respectively;
sign displaying means for displaying a sign on a display screen, a direction of which sign is recognizable; and
mode switching means for switching between (i) an orientation following mode in which the sign displaying means changes the direction of the sign in accordance with the orientation of the twin-lens image capturing device and (ii) an orientation maintaining mode in which the sign displaying means causes a direction of the sign, which direction is displayed while the twin-lens image capturing device is in the regular orientation, to be maintained,
the mode switching means switching to the orientation maintaining mode in a case where the first and second image capturing sections capture a right-eye image and a left-eye image, respectively.

2. The twin-lens image capturing device as set forth in claim 1, wherein, in the orientation maintaining mode, the sign displaying means changes, in accordance with the orientation of the twin-lens image capturing device, a location on the display screen at which location the sign is displayed.

3. The twin-lens image capturing device as set forth in claim 1, wherein, in the orientation maintaining mode, the sign displaying means causes a location on the display screen, at which location the sign is displayed while the twin-lens image capturing device is in the regular orientation, to be maintained even in a case where the orientation determining means determines that the twin-lens image capturing device is not in the regular orientation.

4. A twin-lens image capturing device as set forth in claim 1, further comprising:
alerting means for issuing, in a case where the twin-lens image capturing device is upside down when instructing the first and second image capturing sections to respectively capture a right-eye image and a left-eye image, an alert indicating that the twin-lens image capturing device is upside down, which alert is issued in an orientation in accordance with the orientation of the twin-lens image capturing device.

5. A twin-lens image capturing device as set forth in claim 1, further comprising:
planar image capturing means for capturing a planar image by use of one of the first and second image capturing sections,
the mode switching means switching to the orientation following mode in a case where the planar image capturing means captures a planar image.

6. The twin-lens image capturing device as set forth in claim 1, wherein the sign displayed by the sign displaying means includes a sign for instructing the first and second image capturing sections to capture a right-eye image and a left-eye image, respectively.

7. The twin-lens image capturing device as set forth in claim 1, wherein the sign displayed by the sign displaying means includes a sign for instructing the mode switching means to switch between the orientation following mode and the orientation maintaining mode.

8. The twin-lens image capturing device as set forth in claim 1, wherein:
the sign displayed by the sign displaying means includes a sign for instructing the mode switching means to switch between the orientation following mode and the orientation maintaining mode; and
in a case where the twin-lens image capturing device is upside down while in the orientation following mode, the mode switching means carries out at least one of (i) issuance of an alert indicating that the twin-lens image capturing device is upside down and (ii) prohibition of switching to the orientation maintaining mode.

9. (canceled)

10. A computer-readable storage medium in which a program is stored,
the program controlling a twin-lens image capturing device to:
(a) determine whether or not an orientation of the twin-lens image capturing device is a regular orientation in which the first and second image capturing sections can capture a right-eye image and a left-eye image, respectively;
(b) change a direction of a sign, which direction is recognizable, in accordance with the orientation determined in the step (a);
(c) cause a direction of the sign, which direction is displayed while the twin-lens image capturing device is in the regular orientation, to be maintained; and
(d) switch from the step (b) to the step (c) in a case where the first and second image capturing sections capture a right-eye image and a left-eye image, respectively.

11. A method of controlling a twin-lens image capturing device, which comprises first and second image capturing sections for respectively generating a right-eye image and a left-eye image which are used to generate a stereoscopic image,
said method comprising the steps of:
(a) determining whether or not an orientation of the twin-lens image capturing device is a regular orientation in which the first and second image capturing sections can capture a right-eye image and a left-eye image, respectively;
(b) changing a direction of a sign, which direction is recognizable, in accordance with the orientation determined in the step (a);
(c) causing a direction of the sign, which direction is displayed while the twin-lens image capturing device is in the regular orientation, to be maintained; and
(d) switching from the step (b) to the step (c) in a case where the first and second image capturing sections capture a right-eye image and a left-eye image, respectively.
